(19) United States
(12) Patent Application Publication
(10) Pub. No.: US 2026/0298762 A1
(43) Pub. Date: Oct. 1, 2026

(54) HYDRAULIC ANALYSIS PLATFORM

(71) Applicant: Utilimatics, LLC, Austin, TX (US)

(72) Inventors: Andrew Boyle, San Jose, CA (US); Christopher Kite, Spicewood, TX (US)

(73) Assignee: Utilimatics, LLC, Austin, TX (US)

(21) Appl. No.: 19/096,740

(22) Filed: Apr. 1, 2025

(51) Int. Cl. G01M 3/26; G06Q 50/06

(52) U.S. Cl. CPC G01M 3/26; G06Q 50/06

(57) ABSTRACT

Examples of the present disclosure are directed to detecting and localizing anomalous water usage in a water distribution network, including water loss events and regulated demand violations. A method may include acquiring sensor data comprising pressure data and/or flow data from sensors throughout the network; comparing acquired sensor data with historical data under similar conditions or expected values based on hydraulic models; determining whether deviations exist; initiating analysis when deviations are detected, including hydraulic simulations for pressure anomalies or consumption pattern analysis for flow anomalies; and identifying the probable location of anomalous usage. Aspects further provide a hydraulic analysis platform integrating operational and asset management datasets to manage water distribution networks and provide regulated demand detection. Regulated demand violations may include irrigation activation outside permitted hours, usage exceeding volume limits, pool filling during restricted periods, unauthorized hydrant usage, or illegal connections to the network.

### CROSS-REFERENCE TO RELATED APPLICATIONS

This Application claims the benefit of and priority to U.S. Provisional Patent Application No. 63/683,194, filed on Aug. 14, 2024, the entire contents of which are hereby incorporated by reference.

### BACKGROUND

Water scarcity, inefficient water usage, and inadequate monitoring of water systems have become significant challenges in modern societies. The increasing global population, urbanization, and industrial growth have placed immense pressure on water resources, necessitating the implementation of smart and reliable water management solutions. Municipal water utilities face immense challenges balancing supply and demand across interconnected distribution networks serving populaces with varying demographics, climates, and consumptive behaviors. Straining resources necessitate implementing targeted water conservation measures and usage restrictions while maintaining infrastructure integrity and customer satisfaction. However, enforcement of restrictions remains largely manual relying on in-person audits, neighbor reports, or exceeding simplistic volume thresholds—proving inadequate data for precision monitoring across large heterogeneous consumer bases.

It is with respect to these and other general considerations that examples have been described. Although relatively specific problems have been discussed, the examples described herein should not be limited to solving the problems identified in the background above.

### SUMMARY

Recent smart water meter deployments improve visibility into customer-level usage but generate overwhelming data requiring robust analytics. Conventional meter data platforms lack capabilities to cost-effectively translate raw usage reads into actionable policy violation detection responsive to nuanced allowance parameters. Incidents often go unnoticed or produce false positives failing to achieve sustainable conservation. Water suppliers need reliable automated enforcement technologies mapped to specific usage restrictions that provide transparency for consumers and configurability for administrators.

In view of the preceding background, it is, therefore, an object of the present disclosure to provide a hydraulic analysis platform that integrates disparate operational and asset management utility datasets into a single interface to manage a hydraulic distribution network of a water utility and to provide regulated demand detection, such as but not limited to the detection of irrigation or the filling of pools on days where a utility has banned that type of usage for a certain address. Such datasets can include but are not limited to Geographic Information Systems (GIS), Supervisory Control and Data Acquisition (SCADA), Advanced Metering Infrastructure (AMI), and one or more hydraulic models, where a hydraulic model may be specific to a geographic location or may be a general hydraulic and/or data model utilizing standardized input and output data. The hydraulic analysis platform can receive sensor readings from one or more data providers, where the sensor readings may refer to water flow and water pressure measured at various locations throughout a zone of a water utility. In some examples, the data providers can include public or private data providers. For example, a water utility may be divided into one or more zones or districts, where each zone or district can include primary water meters capable of measuring water flowing into the zone or district and/or water leaving the zone or district. In some examples, other public and/or private sensors within the zone or district can be utilized by the hydraulic analysis platform, where the hydraulic analysis platform can receive the sensor information. In accordance with examples of the present disclosure, the hydraulic analysis platform can ingest from one or more data providers, receive sensor information directly from one or more sensors, and/or combinations thereof, where such data can be provided in real-time, at timed intervals, or in accordance with a scheduled event.

In examples, the hydraulic analysis platform can utilize each of the aforementioned datasets to provide a streaming interface that allows a user to view conditions in a zone or district for a specified time period for which sensor data is acquired, analyzed, and/or recorded. In some examples, the hydraulic analysis platform can include a data model, which catalogs and analyzes data from one or more sensors, and a hydraulic model, which models the physical interactions of the water flowing through the zone or district. The inputs and outputs of the data model and the hydraulic model can overlap considerably. For example, the hydraulic analysis platform can utilize sensor data to complete a water mass balance at a boundary of the zone or district, such as at pressure zones and/or at district metered areas. The water mass balance is the sum of all water flow entering the zone or district less water flow leaving the zone or district and water flow entering and/or exiting storage vessels. The hydraulic analysis platform can utilize AMI meters at metered connections and pressure sensors (either connected to SCADA or a separate monitoring database) at points of entry into the zone or district as well as at other points throughout the zone or district.

In some examples, the hydraulic analysis platform, via the data model, can complete a mass balance at periodic timesteps to determine whether the volume of water leaving the zone or system through metered connections is equal to the volume of water entering the zone or system at the boundaries or being stored. If the data model identifies a discrepancy in the mass balance, this indicates potential unmetered water loss such as illegal connections or unauthorized hydrant use. For metered connections, the system may analyze AMI consumption patterns that exceed normal domestic demand baselines to detect regulated demand events occurring outside permitted schedules, such as unauthorized irrigation activation or pool filling. The rate of excessive usage is quantified and applied in the hydraulic model to simulate at various locations across the zone. By comparing consumption patterns from AMI data, the platform can identify and geolocate specific customer connections exhibiting prohibited regulated demand for precise enforcement. The integrated data model can go beyond conventional threshold-based regulation analysis to enact customizable policy-driven usage restrictions. The hydraulic analysis platform provides transparent actionable feedback to consumers to achieve collaborative water stewardship objectives.

If the data model identifies a discrepancy in the mass balance, this indicates potential unmetered water loss such as illegal connections or unauthorized hydrant use. The rate of excessive usage is quantified and input into the hydraulic model to simulate at various locations across the zone. Higher observed water use correlates with lower measured pressures. Thus, the hydraulic model leverages pressure sensors to compare simulated readings to actual measurements and pinpoint the source location of the prohibited usage. For metered connections showing excessive usage in AMI data, the platform identifies specific customer connections where prohibited regulated demand (such as unauthorized irrigation or pool filling) is occurring without requiring hydraulic simulation. The hydraulic analysis platform categorizes these simulated locations to identify the areas most closely matching the monitored remote system pressures for precise violation geolocation. The hydraulic model accounts for previously identified excessive demands still occurring when the system comes online using statistical uncertainty analyses to narrow potential violation sites.

In some examples, detecting and localizing leaks in a water distribution network is described. In some examples, a method may include acquiring pressure data from a plurality of pressure sensors distributed throughout the water distribution network; performing a contextual historical data comparison by comparing the acquired pressure data with historical pressure data under similar demand conditions; conducting an actual versus expected head conditions analysis by comparing the acquired pressure data with expected pressure values based on at least one of historical head conditions and/or a hydraulic model of the network; determining whether deviations exist between the acquired pressure data and at least one of the historical pressure data or the expected pressure values; initiating hydraulic model simulations when deviations are determined to exist; and identifying a most probable leak location based on results of the hydraulic model simulations.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 depicts additional details of a hydraulic analysis platform in accordance with examples of the present disclosure.

FIG. 2 depicts additional details of a hydraulic analysis platform in accordance with examples of the present disclosure.

FIG. 3A depicts additional details of a data structure created to store sensor data and/or GIS data or other data processed by the data model of FIG. 2.

FIG. 3B depicts additional details of example hydraulic models in accordance with examples of the present disclosure.

FIG. 4A depicts an example data table for tracking automated metering infrastructure (AMI) water usage data and detected restriction violations over time for a sample customer in accordance with examples of the present disclosure.

FIG. 4B illustrates an exemplary data structure for encoding water usage regulation rules, restrictions, and allowances that are enforced by the system for different customer and property profiles in accordance with examples of the present disclosure.

FIG. 5 depicts details of methods for identifying deviations existing between simulated results and actual sensor readings in accordance with examples of the present disclosure.

FIG. 6 depicts details of a method for identifying locations of possible water use restriction violations in a district or zone of a water utility in accordance with examples of the present disclosure.

FIG. 7 depicts details of methods for calibrating a hydraulic analysis platform specific to a zone or district of a water utility in accordance with examples of the present disclosure.

FIG. 8 depicts details of a method for selecting a hydraulic model and performing a hydraulic simulation using the selected hydraulic model in accordance with examples of the present disclosure.

FIG. 9 illustrates an automated workflow for detecting violations of permitted water usage schedules based on analysis of automated meter infrastructure (AMI) data relative to customer-specific allowances encoded in utility restrictions in accordance with examples of the present disclosure.

FIG. 10 depicts details of a workflow for detecting violations of water usage regulations from analysis of empirical automated meter readings relative to defined allowances in accordance with examples of the present disclosure.

FIGS. 11A-11B depict details of a first flow chart in accordance with examples of the present disclosure.

FIGS. 12A-12B depict details of a second flow chart in accordance with examples of the present disclosure.

FIGS. 13A-13B depict details of a third flow chart in accordance with examples of the present disclosure.

FIG. 14 is a block diagram illustrating physical components (e.g., hardware) of a computing system, such as a hydraulic analysis platform, with which aspects of the disclosure may be practiced.

FIG. 15 depicts additional details of a system for processing data in accordance with examples of the present disclosure.

FIG. 16 depicts details of a method for detecting and localizing leaks in a water distribution network in accordance with examples of the present disclosure.

FIG. 17 depicts details of a method for verifying permitted water usage allowances in accordance with examples of the present disclosure.

### DETAILED DESCRIPTION

In the following detailed description, references are made to the accompanying drawings that form a part hereof and which are shown by way of one or more illustrations of one or more examples. These aspects may be combined, other aspects may be utilized, and structural changes may be made without departing from the present disclosure. Examples may be practiced as methods, systems, and/or in accordance with swing training apparatus structures. The following detailed description is, therefore, not to be taken in a limiting sense, and the scope of the present disclosure is defined by the appended claims and their equivalents.

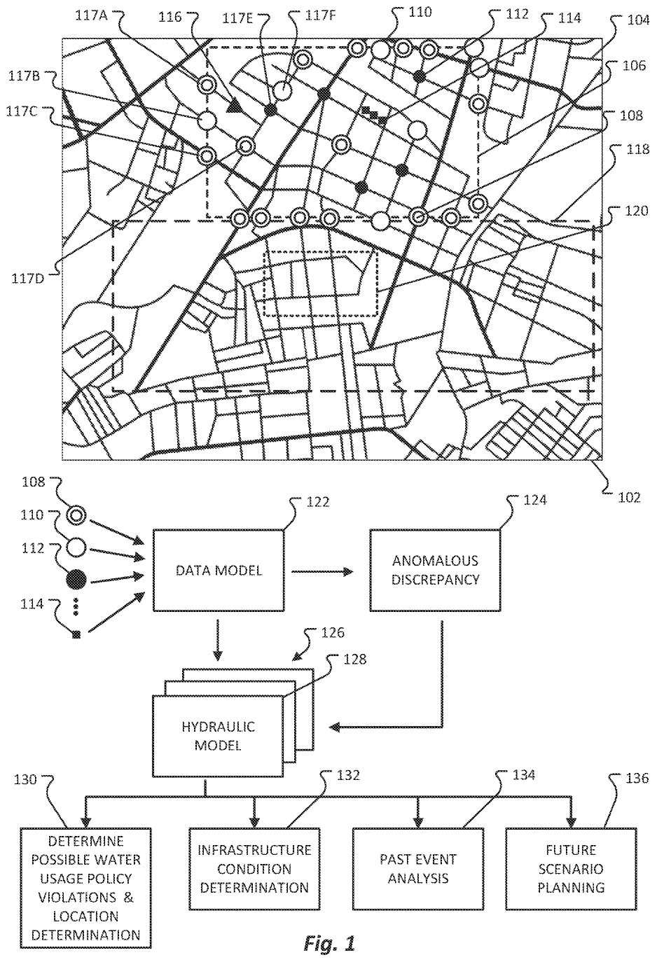

FIG. 1 depicts additional details of a hydraulic analysis platform in accordance with examples of the present disclosure. The hydraulic analysis platform can provide a user interface or otherwise a depiction 102 of one or more zones or districts of one or more water utilities as depicted by reference character. For example, a depiction 102 may include a plurality of water lines 104, where each water line 104 may correspond to one or more aspects of a water utility infrastructure. For example, the water lines 104 may be different sizes, made of different materials, run in different directions, and may be connected to or coupled to one another thereby creating a water utility infrastructure. As further depicted in FIG. 1, a first district or zone 106 is illustrated, where the district or zone 106 can include a plurality of water lines 104 and a plurality of sensors. That is, a first sensor 108 can include a sensor capable of measuring or otherwise obtaining pressure and/or flow readings for one or more water lines 104. As another example, a second sensor 110 may be a sensor capable of reading or otherwise obtaining a pressure reading of one or more water lines. In some examples, other sensors 112 and/or 114 may be capable of reading pressure and/or flow at different intervals as well as the other sensors 112 and/or 114 may reside within the district or zone 106. In some examples, the first sensor 108 and the second sensor 110 may be located at a boundary of the district or zone 106. That is, water flowing into district or zone 106 can be measured and water flowing out of the district or zone 106 can be measured. In some examples, one or more other sensors 112 and/or 114 can measure a stored amount of water, for example, in a water tower, water facility, containers, vessels, or otherwise. Thus, for example, when a mass water balance is performed on district or zone 106, the water flowing in can match the water flowing out, while considering the water being stored in one or more storage vessels. In some examples, the mass water balance can consider previously identified leaks and/or take into consideration regulated water demand (e.g., irrigation, filling swimming pools, or other uses of large amounts of water in accordance with water usage policies and/or water restrictions) flowing out of the district or zone 106 at one or more connections within the district or zone 106. For example, AMI data for connections within district or zone 106 can be used when performing the mass water balance. If a discrepancy is detected in the balanced flows per the water usage policies, this suggests a potential regulated demand violation 116. Further hydraulic modeling pinpoints high-probability locations of unauthorized water use like irrigation activation based on pressure correlations.

As further depicted in FIG. 1, other zones or districts (e.g., zone or district 118) can be displayed to a user or otherwise considered by the hydraulic analysis platform. That is, the zone or district 118 can refer to another zone or district and in some instances can be adjacent to the zone 106 or district. In accordance with some examples, a zone or district can include a subzone or district, such as the district or subzone 120 within the zone or district 118. Thus, water flow and pressure readings can be obtained or otherwise localized to a portion of the zone or district 118 (e.g., to the district or subzone 120).

In accordance with some examples of the present disclosure, pressure, and flow readings from a first sensor 108 (e.g., pressure and/or flow sensor), second sensor 110 (e.g., pressure sensor), and other sensors 112 and/or 114 can be provided to the data model 122. As previously discussed, the data model 122 can receive these sensor readings, process the sensor readings, and store the sensor readings as sensor data. In some examples, the data model can further predict or otherwise determine other sensor readings for other portions of a district or zone. For example, where a pressure and/or flow reading is obtained at a first end of a water line, and a pressure or flow reading is obtained for a second end or portion of the water line, the data model can predict a pressure and/or flow within the specific water line at locations between the first end and the second end. In accordance with some examples of the present disclosure, the data model 122 can utilize one or more sub models to predict water demand. As one example, the water demand can be predicted using one or more machine learning models and/or an Auto-Regressive Integrated Moving Average (ARIMA) model. As one example, neural networks can be trained on historical AMI data to forecast expected water usage volumes across future intervals. These usage predictions leverage insights into prior consumption patterns, weather forecasts, and other covariates to estimate baseline demand needs. The models dynamically incorporate the applicable water usage restrictions and conservation policies to modify the predictions, limiting projected demands to permitted schedules. For example, a predicted base demand for landscaping irrigation on a given day is overridden if watering is prohibited on that date under current policy rules. The policy-constrained demand forecasts provide regulators valuable visibility into anticipated compliance needs and risk factors highlighting areas requiring preemptive interventions.

In accordance with some examples of the present disclosure, and as previously discussed, a water mass balance process can be performed for one or more districts or zones. This compares measured inflows to outflows and storage volumes to quantify any excessive unexplained consumption. Specifically, unexplained consumption can be the difference between expected water demand usage based on historical patterns complying with usage restrictions versus actual readings indicating volumes beyond permitted schedules.

For example, past data may dictate a summer weekday demand of 500 gallons per minute expected for a home based on normal indoor and preset outdoor allotments. However, the mass balance and/or metered readings indicates actual consumption of 700 gallons per minute—a discrepancy of 200 gallons per minute relative to the baseline compliant profile. This deviation is categorized as an unexplained consumption event indicating the detection of a likely regulation violation such as irrigation activation exceeding allocated limits or during prohibited hours. In some aspects, the unexplained consumption event may be referred to as an illegal connection or discharge, for example water theft.

The unexplained consumption provides an indicator tied to coded policy constraints. The integrated mass balance and/or metered readings analysis and baseline demand violation allows enacting configurable restriction rules mapped to utility objectives beyond coarse demand thresholds detached from requirements.

Further, one or more hydraulic models 126 can be utilized to identify a possible location of unregulated demand when a discrepancy has been identified. For example, a specific hydraulic model 128 can receive sensor data from the data model 122 and can utilize the amount of unexplained consumption to determine a possible site of unauthorized water use such as irrigation activation. That is, a simulation with the quantified excessive demand applied at various points throughout the zone's infrastructure can be used to pinpoint probable locations of policy violations. Such simulations can identify the exact physical address where the policy violation is occurring by, for example, comparing historical data to the current flow rate.

Higher usage rates may correlate directly with lower pressure effects in one or more of simulated and/or physical systems. Since the hydraulic model conditions are based on metered flows, comparing monitored system pressures during detected events with the simulated outputs isolates locations most closely matching the modeled unauthorized utilization as probable violation sites. These simulated sources aligned to measured sensor impacts are categorized and communicated to utility staff for precise enforcement. In some examples, the type of customer notification is adapted based on an attribute of the violation such as excessive volumes warranting urgent alerts.

As an example, a pressure and flow associated with a location 117A can be obtained from one or more sensors along the boundary of the district or zone 106. A hydraulic model can simulate an amount of unexplained, potentially unauthorized usage at various infrastructure nodes within the zone. Accordingly, the model generates simulated flow and pressure readings for junctions 117A-117F reflecting possible sites of improper irrigation activation or other policy violations.

The outputs most closely matching actually measured sensor impacts pinpoint probable locations of prohibited water demands within network interconnections. Localizing the unauthorized utilization sources based on aligned simulated and empirical data patterns allows precise correction guidance. The integrated modeling and instrumentation analysis provides regulators with visibility into granular district operations against usage policies to support water conservation needs.

In some examples, one or more pressure sensors are impulse-enabled pressure sensors capable of identifying pressure impulses. The one or more pressure sensors that are impulse-enabled pressure sensors can sample and record pressures at one or more connections at acquisition rates that are greater than other pressure sensors located throughout district or zone 106. Alternatively, or in addition, one or more pressure sensors capable of acquiring pressure readings at acquisition rates capable of identifying pressure surges can provide such pressure reading to the data model 122 such that the data model can identify a pressure surge. Upon identifying a pressure surge by the impulse-enabled pressure sensor(s) and/or the data model 122, the data model 122 and/or a hydraulic model 128 can initiate an analysis to determine unexplained water consumption in a manner that is the same as or similar to the manner previously discussed. Alternatively, or in addition, based on the identification of a pressure surge event by the data model and/or the impulse-enabled pressure sensor(s), one or more additional process for identifying infrastructure within the district or zone 106 affected (e.g., negatively affected) by the pressure surge event can be initiated. For example, the pressure surge event can potentially be mitigated to prevent the potentially damaging surge event from affecting other parts of the district or zone 106. As a non-limiting example, a pressure surge mitigation action can be accomplished by opening/closing one or more valves.

In some instances, the identified pressure surge event can be stored or otherwise logged for later impulse or surge event identification.

In some examples, the data model 122 and/or the hydraulic model 128 can simulate the operation of a water system to determine possible locations of water usage policy violations or violations of water restrictions 130, allow the user to plan for future scenarios 136, analyze past events 134, and determine the conditions 132 in parts of a system where measurement equipment is not available. For example, the data model 122 can store or log pressure, flow, unregulated demand, and leak event data over time to statistically correlate past events with future potential events. For example, by performing an analysis of one or more past events 134 using data from the data model 122, the identification of a possible or probable future event can be identified.

The data model 122 can use historical data to forecast near-term system demand using machine learning techniques, including autoregressive integrated moving average (ARIMA) methods, neural networks, and other forms of machine learning. For example, future what-if scenarios can be modeled using one or more hydraulic models 126, data from the data model 122, and/or forecasted system demand data.

In some examples, the hydraulic analysis platform can cause hydraulic grade lines to be rendered across several computing devices in real or near-time and at any timestep between two points in the zone or district. The hydraulic grade line corrects for elevation so that losses due to friction, bends, and usage can be quickly and accurately displayed from sources like pumps to any point in the system. The elevation model and hydraulic analyses from the hydraulic model facilitate this process within the hydraulic analysis platform.

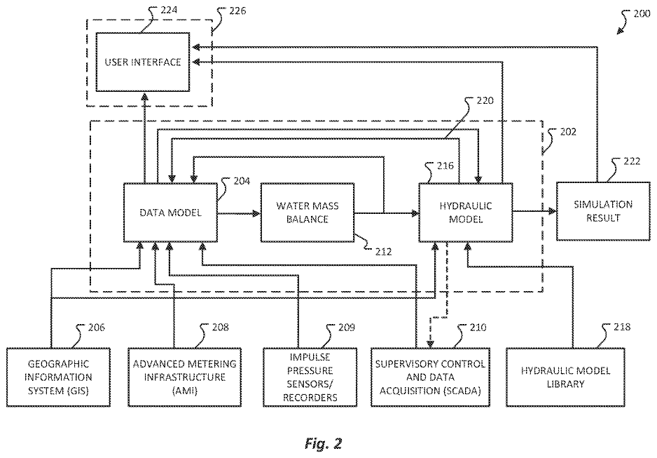

FIG. 2 depicts additional details of a hydraulic analysis platform 200 in accordance with examples of the present disclosure. As previously discussed, a hydraulic analysis platform 200 can include a data model 204 and a hydraulic model 216. Computations for the hydraulic analysis platform 200 can be performed utilizing computing system 202. In some examples, the data model 204 can receive sensor data and/or infrastructure data for a zone or district from a geographic information system 206, an advanced metering infrastructure (AMI) 208, impulse pressure sensors/recorders 209, and a supervisory control and data acquisition systems (SCADA) 210. The hydraulic analysis platform 200 can receive information from the geographic information system 206, where the information can include a network file layout that includes characteristic information for a water utility layout, district, or zone. As previously discussed, the hydraulic analysis platform 200 can receive sensor data specific to one or more sensors such as a flow sensor, pressure sensor, etc. for a zone or a district from the AMI 208. In some examples, the data model 204 can ingest the information or the sensor data from an AMI source and/or directly access the information or the sensor data from an AMI source. Alternatively, or in addition, the data model 204 can ingest the information or the sensor data from an information provider that obtains sensor data from an AMI source. In some instances, the AMI source and/or the information provider can push sensor data or other information directly to data model 204. As previously discussed, the data model 204 can additionally receive sensor data and in some instances control data from SCADA 210.

In examples, a water mass balance process 212 can be performed based on sensor data received from the AMI 208, SCADA 210, and other sensors located in a district or zone. That is, where the water flow into a zone our district is different than a water flow out of a zone or district as determined by the water mass balance process 212, a hydraulic model 216 can be selected to further analyze the district or zone for a possible water use violation. As previously discussed, the water mass balance process 212 can consider water leaving the zone or district as a result of being stored in storage containers, vessels, or otherwise.

In some examples, a simulation result of the hydraulic model 216 can be output as a simulation result 222. The simulation result 222 can refer to the unexplained water use or unregulated demand location, event, condition, and/or future demand as described with respect to FIG. 1. In accordance with some examples of the present disclosure, the simulation result 222 can be provided to a computing device 226 such that the simulation result can be rendered to or otherwise displayed at a user interface 224 coupled to the computing device 226. In some examples, the computing device 226 can access data from the data model, simulation result 222, and/or hydraulic model 216 via a web interface provided by the computing system 202.

In accordance with some examples of the present disclosure, where a water mass balance process 212 does not identify a discrepancy between the water flowing into and out of the district or zone, the hydraulic analysis platform 200 can continue to log sensor data together with the result of the water mass balance process 212. Where a potential site 220 of excessive demand is provided by the hydraulic model 216, this information on the location of the likely policy violation is forwarded to the data model 204 for subsequent logging and further analysis.

In some examples, the data model 204 provides updated sensor readings to the hydraulic model 216 to retrain machine learning components on recent data. For instance, neural networks can refine simulations correlating pressure patterns to sources of unauthorized utilization. Training on empirical observations from policy violation events helps continuously improve precision. As additional incidents transpire across the water distribution network, the integrated modeling automation gets smarter, adapting to evolving usage behaviors and infrastructure modifications to sustain reliable compliance enforcement.

As further depicted in FIG. 2, the hydraulic analysis platform 200 can provide a signal to the SCADA 210. In examples, the signal provided to the SCADA 210 can be configured to control a valve located in the zone of the water utility. For example, based on a location of a possible violation (e.g., illegal connection or unauthorized usage) as determined by the hydraulic model 216, a valve closest to the possible violation may be closed based on the signal provided to the SCADA 210 from the hydraulic analysis platform 200. That is, the hydraulic analysis platform 200 can optionally push information back to the SCADA 210. In non-limiting examples, the hydraulic model 216 can provide the information that is sent to the SCADA 210, as depicted by the dashed line in FIG. 2. In some examples, the hydraulic model 216 may be selected from the hydraulic model library 218.

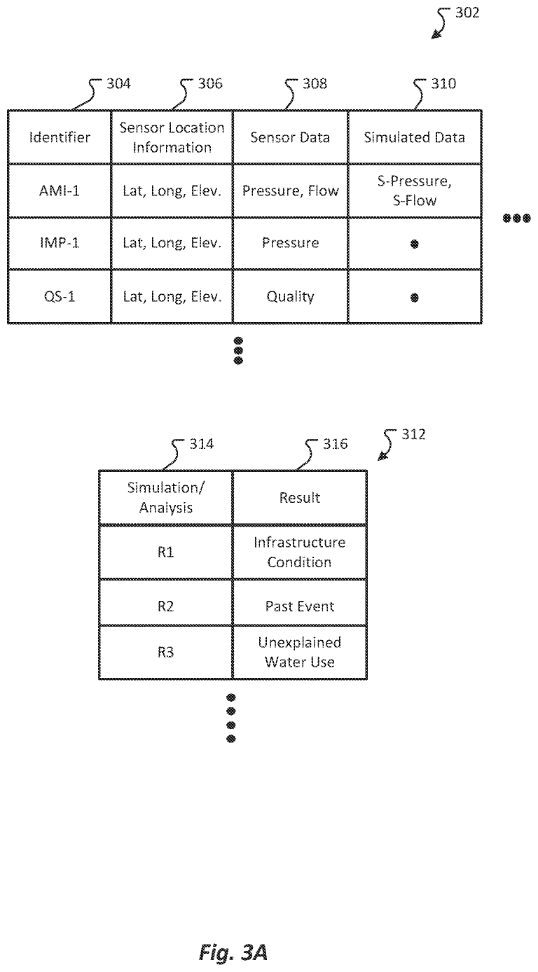

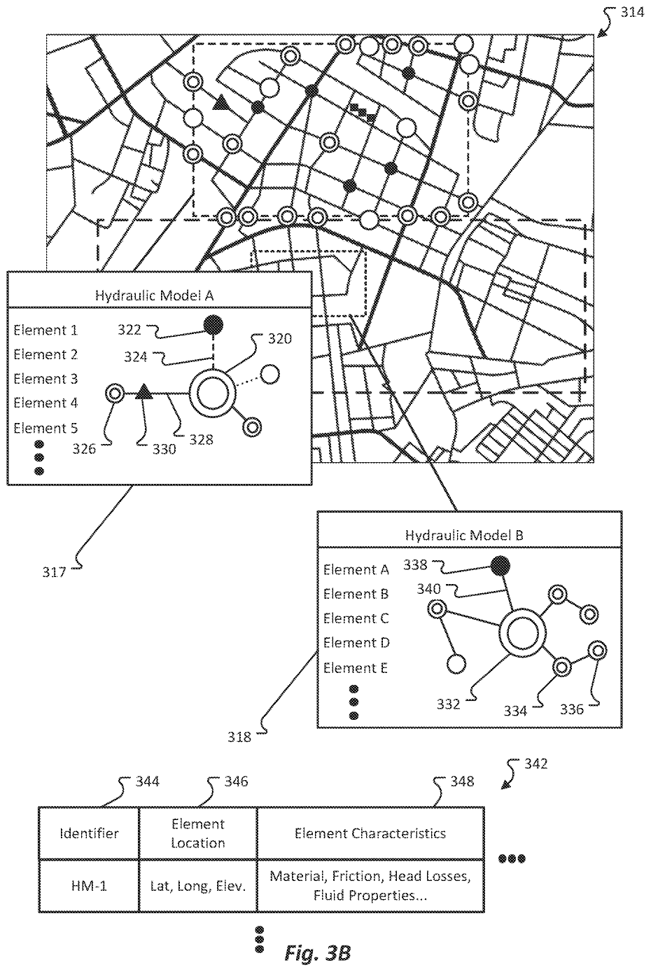

FIG. 3A depicts additional details of a data structure 302 created to store sensor data and/or GIS data or other data processed by the data model 204 of FIG. 2. In some examples, the data model 204 of FIG. 2 can identify one or more sensors utilizing an identifier 304. In some examples, the data model 204 of FIG. 2 can save or store such information, such as but not limited to, sensor location information 306, sensor data 308, simulated data 310, and any other sensor data. In some examples, the sensor data can refer to impulse pressure data, water quality data, SCADA data, etc. In some implementations, another data structure 312 can be utilized to store or otherwise log simulation or analysis data generated by the data model and/or a hydraulic model. For example, a simulation or analysis can be identified using the identifier 314 and the result of simulation or analysis can be stored in accordance with the result field 316. Thus, for example, one or more simulations or analyses can be performed, and different results can be received and logged for future use. Of course, additional fields may be included in the data structure 302 and/or data structure 312, although not depicted in FIG. 3A.

FIG. 3B depicts additional details of a hydraulic model, such as a hydraulic or data model 317 and/or a hydraulic or data model 318. In examples, the hydraulic or data model 317 and/or hydraulic or data model 318 can be utilized to simulate different aspects of a district or zone. For example, a hydraulic or data model 317 can be used to identify or potentially identify one or more water use violations in a district or zone. As depicted in FIG. 3B, the hydraulic or data model 317 can include a plurality of different elements and a mapping of each element with respect to another element, where each element can be coupled to or otherwise connected to another element. Thus, for example, sensor data from one or more of sensor 320, sensor 322, sensor 324, sensor 326, and/or sensor 328 can be utilized to identify an unexplained water usage 330 such as in response to unregulated demand or violation of one or more water use policies. As another example, the hydraulic or data model 318 can be utilized to predict water demand. Thus, similar to the hydraulic or data model 317, the hydraulic or data model 318 can include one or more sensors 332-338 (e.g., one or more of sensor 332, sensor 334, sensor 336, and/or sensor 338), where each of the one or more sensors 332-338 can be associated with one or more characteristics, such as material, friction, head losses, fluid properties, etc. In some examples, the hydraulic model, such as the hydraulic or data model 318, can include one or more characteristics, such as material, friction, head losses, fluid properties, etc., of other portions of the district or zone, such as a pipe or connection 340. Thus, the hydraulic or data model 318 can be used to determine or otherwise identify one or more characteristics of the district or zone. In accordance with examples of the present disclosure, each of the hydraulic or data models, such as but not limited to hydraulic or data model 317 and/or hydraulic or data model 318, can be based on or otherwise created from GIS information.

As further depicted in FIG. 3B, a hydraulic model, such as hydraulic or data model 317 and/or hydraulic or data model 318, can be stored in a data structure 342. The data structure 342 can include an identifier 344 uniquely identifying the hydraulic model, location information 346 and/or characteristic information 348 for each of the hydraulic models. Although not explicitly indicated in FIG. 3B, the data structure 342 can include additional hydraulic models and hydraulic model information.

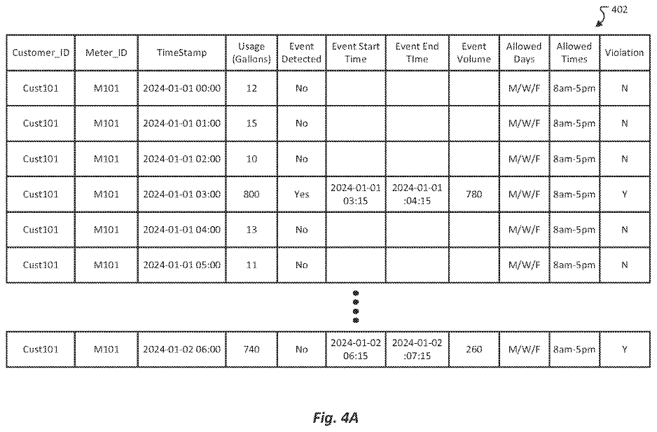

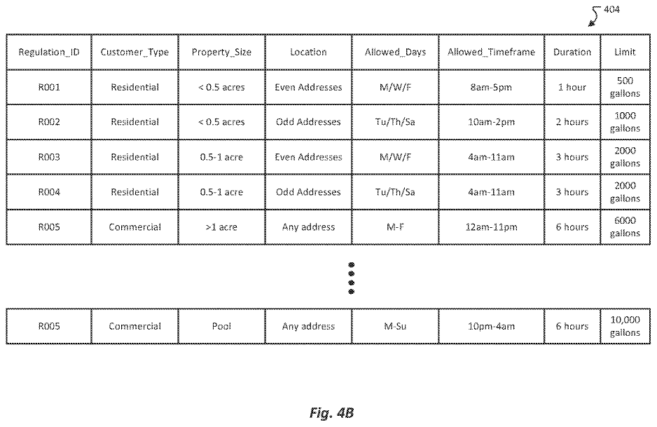

FIG. 4A illustrates an example data structure 402 for tracking automated metering infrastructure (AMI) water usage data and detected restriction violations over time for a sample customer. The table contains identifier information such as a street address, global positioning system (“GPS”) or other geographic coordinates, customer ID and/or meter ID, raw AMI readings showing usage volume per hour, automated event detection outputs quantifying suspected violation details, applicable schedules and rules, and violation flags. In particular, hourly interval data from smart water meter M101 is depicted for exemplary customer Cust101 over Jan. 1 and 2, 2024 (see column 1). This includes gallon usage values per hour such as 12 gallons at midnight and 15 gallons at 1 AM on January 1st (column 3). The readings enable the development of complete usage profiles over days, weeks, and months.

In some aspects, a hydraulic model 216 and/or data model 204 may analyze deviations in AMI volumes from normal baseline trends to discover possible violation incidents (column 4). For the 3 AM interval on January 1st, an event is flagged denoting suspicion of improper irrigation activation or similar violation. Event properties are quantified including 800 total gallons consumed, starting at 3:15 AM and ending at 4:15 AM (columns 5-7). The detected 780-gallon event volume is checked against permitted allowances for even/odd addresses, times, days, and volumes encoded in utility restriction rules (columns 8-10). For Cust101, irrigation is allowed only 8 am-5 pm M/W/F up to 500 gallons per hour. Since the 3 AM event falls outside this schedule, it is marked as a regulatory non-compliance (column 10). Similar violation checking is performed hour-by-hour for all intervals.

FIG. 4B illustrates an exemplary data structure 404 for encoding water usage regulation rules, restrictions, and allowances that are enforced by the system for different customer and property profiles. The table maps various criteria like property size, address parity, and customer classifications to permitted activation days, time windows, durations, and volumes for regulated demands (see column 1).

As an example, regulation R001 applies for residential properties less than 0.5 acres with even numbered street addresses (columns 2-3). For this customer segment, irrigation scheduling is unrestricted on Mondays, Wednesdays and Fridays, but constrained to the 8 AM to 5 PM timeframe (column 4). Any detected system activation events on R001 designated properties are flagged as violations if occurring outside this Monday/Wednesday/Friday day-of-week restriction or 8 AM to 5 PM hour-of-day allowance. A single event cannot exceed 1 hour or 500 gallons without triggering an infraction alert (columns 5-6).

Regulation R005 demonstrates that alternate criteria can yield different allowances, in this commercial case enabling irrigation anytime/day up to 6000 gallons per event (columns 2, 4-6). Rulesets adapt to village ordinances, drought conditions, and consumer attributes balancing conservation with community needs. The encoded mappings provide policy-embedded context to decide if an identified excessive demand incident qualifies as an actual non-compliant violation based on user-specific schedules.

FIG. 4B thus enables configuring regulated demand restrictions as codified references mapped to smart meter data analytics. Checking empirical usage incidents against customer-tailored allowances improves upon conventional monolithic volume limits detached from requirements. The integrated structure also allows policies to adapt responsively by targeting priorities as necessary for a growing, heterogeneous consumer base.

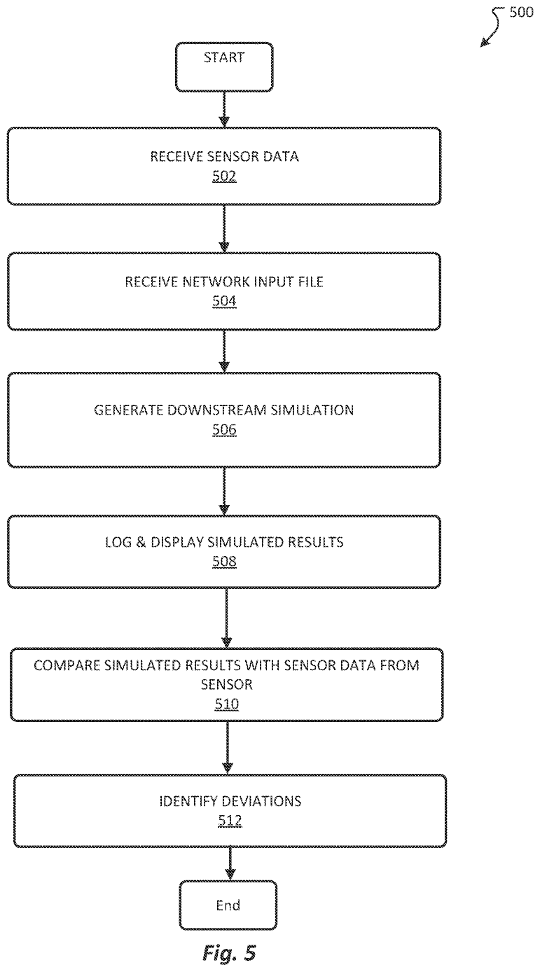

FIG. 5 depicts details of method 500 for identifying deviations existing between simulated results and actual sensor readings in accordance with examples of the present disclosure. A general order for the steps of method 500 is shown in FIG. 5. The method 500 may include more or fewer steps or may arrange the order of the steps differently than those shown in FIG. 5. Method 500 can be executed as a set of computer-executable instructions executed by a computer system and encoded or stored on a computer-readable medium. In examples, aspects of the method 500 are performed by one or more processing devices, such as a computer or server. Further, method 500 can be performed by gates or circuits associated with a processor, Application Specific Integrated Circuit (ASIC), a field programmable gate array (FPGA), a system on chip (SOC), or other hardware device. Hereinafter, method 500 shall be explained with reference to the systems, components, modules, software, data structures, user interfaces, etc. described in conjunction with FIGS. 1-4B.

The method 500 starts and proceeds to 502, where sensor data can be received. In examples, the sensor data can be acquired by the data model, such as the data model 204 of FIG. 2 and/or the data model 122 of FIG. 1. As previously discussed, the sensor data can be pushed to the data model such that the sensor data is received at 502, or the data model can make a request for the data in accordance with a timed event or at the direction of a user. The method 500 can then proceed to 504, where a network input file can be received by the data model. That is, the network input file can refer to a file including various components of a zone or district, how each of the components are related, and/or other characteristics of the components. The rate at which the data model requests sensor data can be dependent upon the type of sensor data, access to the sensor data, and/or requirements of a hydraulic model. The method 500 can then proceed to 506, where the method 500 can generate downstream simulation data. In examples, the downstream simulation data can refer to data that is used to backfill or otherwise establish pressure and/or sensor readings for areas of a zone or district that may be unavailable. Alternatively, or in addition, the downstream simulation may refer to simulated sensor data for one or more sensors based on historical or information and boundary sensor data. For example, where a sensor is located within a district or zone, a simulated sensor reading for the sensor within the district or zone can be based on sensor data from a sensor located at the boundary. Thus, for instance, where a pressure or flow drop occurs over a specified period of time, simulated sensor data may deviate from actual sensor data received from the sensor. In some examples, a hydraulic model can be used to estimate or otherwise generate simulated sensor data downstream from a boundary sensor.

The method 500 can then proceed to 508, where the simulated data and/or results can be logged and/or provided to a computing device for rendering at a display device. In some examples, the logged results can be utilized to update, retrain, or finetune a machine learning model. In some examples, the method 500 can proceed to 510, where the simulated results or simulated sensor data can be compared with the actual sensor data received from the sensor. In some examples, the comparison can be performed by a machine learning model trained on training data specific to a district or zone. In some examples, the comparison can be performed by a machine learning model trained on training data from other districts or zones. The method 500 can then proceed to 512 where one or more deviations between the simulated sensor data and the actual sensor data can be identified. For example, based on the comparison at 510, a deviation greater than a specific threshold may cause an alarm condition such that one or more users are notified. As another example, a deviation greater than a specific threshold can trigger or otherwise cause another analysis or simulation to occur-for example, an unregulated demand model or other hydraulic model to run. The method 500 may then end.

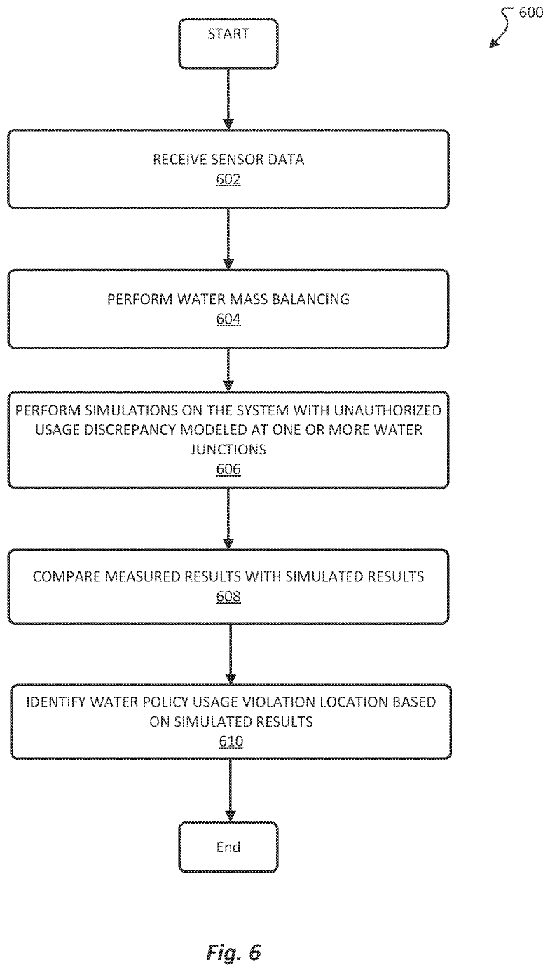

FIG. 6 depicts details of method 600 for identifying locations of possible water use restriction violations in a district or zone of a water utility in accordance with examples of the present disclosure. A general order for the steps of method 600 is shown in FIG. 6. The method 600 may include more or fewer steps or may arrange the order of the steps differently than those shown in FIG. 6. Method 600 can be executed as a set of computer-executable instructions executed by a computer system and encoded or stored on a computer readable medium. In examples, aspects of the method 600 are performed by one or more processing devices, such as a computer or server. Further, method 600 can be performed by gates or circuits associated with a processor, Application Specific Integrated Circuit (ASIC), a field programmable gate array (FPGA), a system on chip (SOC), or other hardware device. Hereinafter, method 600 shall be explained with reference to the systems, components, modules, software, data structures, user interfaces, etc. described in conjunction with FIGS. 1-5.

The method 600 starts and proceeds to 602, where sensor data is received by the data model. As previously discussed, this empirical meter data can be pushed to the system or requested based on timed intervals or user direction. The input data encompasses network infrastructure specifications detailing relationships between the various water distribution components. At 604, a water mass balance process is performed by comparing measured flows into versus out of a zone with storage vessels.

When an unauthorized usage discrepancy is detected at 606 relative to permitted demand schedules, the quantity of excessive consumption is determined. The hydraulic model simulates this unregulated utilization rate applied at potential locations throughout the network. Comparing resulting simulated sensor readings with actual remote impacts isolates probable sites of prohibited water use. Since hydraulic conditions reflect measured volumes, matching simulated and monitored pressures pinpoint locations.

Method 600 can proceed to 608, where monitored system pressures during detected events are compared to hydraulic model simulated outputs with unauthorized utilization applied at potential locations. Matching actual readings with synthesized patterns pinpoints sources of excessive demands deviating from allowances. Sites most accurately emulating measured unauthorized consumption impacts based on physics correlations reveal violations for precise correction. These simulated locations closely aligned to sensors are recorded and categorized to utility staff as possible breaches of a water usage policy indicating needed enforcement at 610.

In some examples, readings from smart meters and pressure sensors identify sites of potential non-compliant utilization. Specifically, measurable discrepancies between expected and actual water volumes in a sub-zone imply areas of possible unauthorized activation for deeper analysis. For unmetered losses such as illegal connections or unauthorized hydrant use, the hydraulic model may perform granular simulations applying this sub-zone excessive rate across infrastructure nodes to emulate resulting pressures from various potential violation sources. For metered connections, excessive usage is identified directly from AMI data without requiring hydraulic simulation.

Accordingly at 608, monitored pressure readings are matched to simulated node outputs to categorize components closely emulating detected events. The integrated network, meter and model analysis reveals locations of transgressions for precise administration of policies balancing supply and community enlightenment. Ongoing situational infrastructure fusion informed by data science sustains reliable usage compliance improvements consistent with stewardship maturity. The method 600 can then end and/or repeat in accordance with a timed or scheduled event or at the direction of a user.

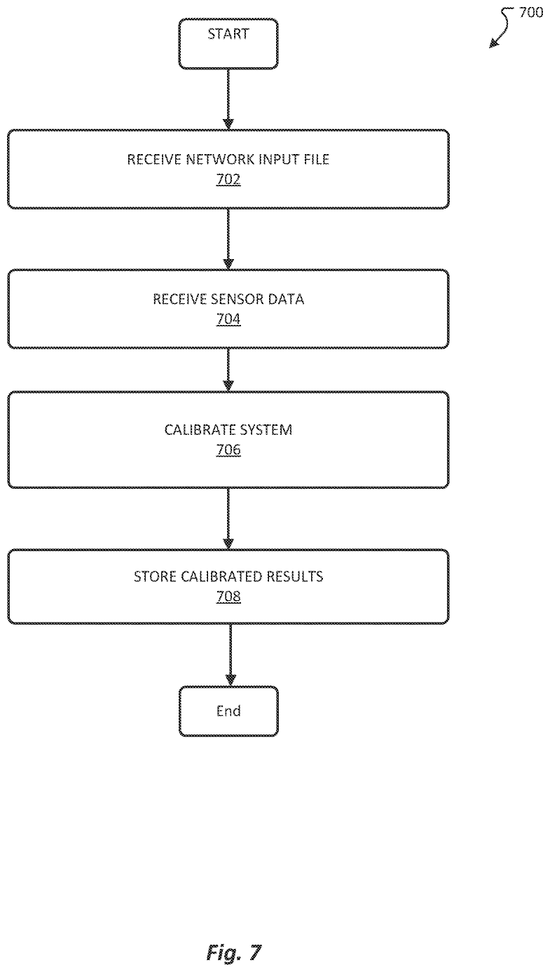

FIG. 7 depicts details of method 700 for calibrating a hydraulic analysis platform specific to a zone or district of a water utility in accordance with examples of the present disclosure. A general order for the steps of method 700 is shown in FIG. 7. The method 700 may include more or fewer steps or may arrange the order of the steps differently than those shown in FIG. 7. Method 700 can be executed as a set of computer-executable instructions executed by a computer system and encoded or stored on a computer readable medium. In examples, aspects of the method 700 are performed by one or more processing devices, such as a computer or server. Further, method 700 can be performed by gates or circuits associated with a processor, Application Specific Integrated Circuit (ASIC), a field programmable gate array (FPGA), a system on chip (SOC), or other hardware device. Hereinafter, method 700 shall be explained with reference to the systems, components, modules, software, data structures, user interfaces, etc. described in conjunction with FIGS. 1-6.

The method 700 starts by receiving a network specification at 702 detailing relationships between the various water distribution components comprising the utility infrastructure. Sensor data is also acquired at 704 reflecting real-time readings of flow volumes and pressure conditions at monitored nodes across sub-zones. The rate of meter information requests adapts based on type, access controls and simulation requirements.

At 706, the analysis platform calibrates hydraulic models based on empirical observations relative to expected data given network variables. Substantial deviations can imply potential sites of pre-existing excessive residual usage predating activations. Statistical uncertainty quantification narrows locations probable of continuing policy non-compliance. That is, when a hydraulic model simulates possible sites of unauthorized water use, there will inherently be some uncertainty in the precise localization. To account for this, a subsequent analysis, such as but not limited to a Monte Carlo analysis, bootstrap aggregation, Bayesian inference, or other uncertainty quantification approach, can be applied. Such a subsequent analyses may run many simulations with slightly varied parameters to quantify the probability distribution over possible violation locations. This allows the analysis platform to narrow down and highlight infrastructure components that have a high statistical probability of representing a site of ongoing excessive water consumption that violates municipal usage policies and restrictions. For example, a particular junction node may be identified as having a 90% chance of being an ongoing source of improper usage activation based on the analysis. If investigations reveal no actual violation, calibration parameters tune alignments between simulated and measured data. The calibration parameters can be stored at 708.

Ongoing calibration maintains precision as modifications, deterioration, and consumer behaviors inherently shift over time. By fine-tuning simulated patterns to correlate with emerging readings, the method 700 can equip regulators to reliably detect new violators amidst dynamic noise caused by variability and fluctuations in water usage data and patterns caused by factors like changes in consumer behavior (e.g., people using more or less water due to vacations, new appliances, etc.), operational changes (e.g., pumps being taken offline, valves opened/closed, infrastructure modifications), environmental conditions (e.g. hot weather increasing usage, rainfall reducing irrigation needs), deterioration—e.g. old pipes developing new leaks, affecting flows, and/or other unexplained variability.

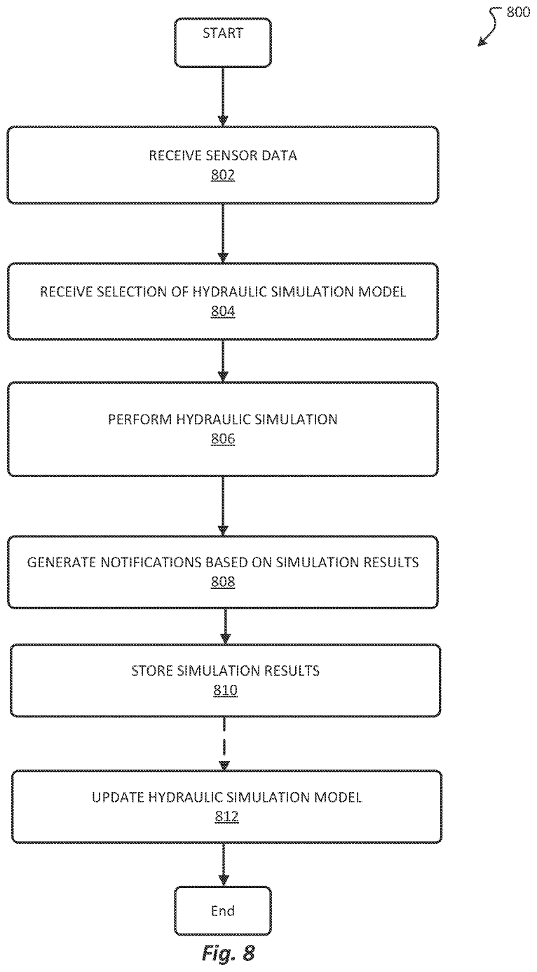

FIG. 8 depicts details of method 800 for selecting a hydraulic model and performing a hydraulic simulation using the selected hydraulic model in accordance with examples of the present disclosure. A general order for the steps of method 800 is shown in FIG. 8. The method 800 may include more or fewer steps or may arrange the order of the steps differently than those shown in FIG. 8. Method 800 can be executed as a set of computer-executable instructions executed by a computer system and encoded or stored on a computer readable medium. In examples, aspects of the method 800 are performed by one or more processing devices, such as a computer or server. Further, method 800 can be performed by gates or circuits associated with a processor, Application Specific Integrated Circuit (ASIC), a field programmable gate array (FPGA), a system on chip (SOC), or other hardware device. Hereinafter, method 800 shall be explained with reference to the systems, components, modules, software, data structures, user interfaces, etc. described in conjunction with FIGS. 1-7.

The method 800 starts and proceeds to 802, where sensor data can be received. In examples, the sensor data can be acquired by the data model, such as the data model 204 of FIG. 2 and/or the data model 122 of FIG. 1. As previously discussed, the sensor data can be pushed to the data model such that the sensor data is received at 802, or the data model can make a request for the data in accordance with a timed event or at the direction of a user. The method 800 can receive as input a network input file. That is, the network input file can refer to a file including various components of a zone or district, how each of the components are related, and/or other characteristics of the components. The rate at which the data model requests sensor data can be dependent upon the type of sensor data, access to the sensor data, and/or requirements of a hydraulic model. Method 800 can then proceed to 804, where a selection of a hydraulic simulation model is received. In some examples, the selection of the hydraulic simulation model is received from a user intentionally desiring to execute a specified simulation. In some examples, the selection of the hydraulic simulation model can be based on one or more possible water usage policy violations determined by the data model.

At 806, the selected hydraulic simulation can be performed by the hydraulic analysis platform or exported as a hydraulic model file to be used with other hydraulic modeling software packages and applications. For example, the hydraulic simulation can be exported as a pre-loaded, ready-to-run hydraulic model file to be used with any common hydraulic modeling software package that can run an EPANET file. Based on the results of the hydraulic simulation, one or more notifications can be generated at 808 and sent to one or more users, and/or the results of the simulation can be stored in a data structure at 810. In some examples, the method 800 can update, retrain, or fine tune one or more hydraulic simulation models at 812 based on the results of the hydraulic simulation performed at 806. For example, where simulated data matches sensor readings, a machine learning model specific to a district or zone can be retrained using training data including the simulation result.

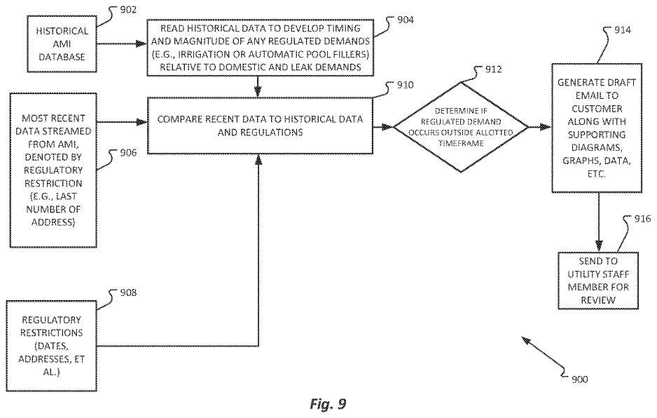

FIG. 9 illustrates an automated workflow 900 for detecting violations of permitted water usage schedules based on analysis of automated meter infrastructure (AMI) data relative to customer-specific allowances encoded in utility restrictions in accordance with examples of the present disclosure. A general order for the workflow 900 is shown in FIG. 9. The workflow 900 may include more or fewer steps or may arrange the order of the steps differently than those shown in FIG. 9. Workflow 900 can be executed as a set of computer-executable instructions executed by a computer system and encoded or stored on a computer-readable medium. In examples, aspects of the workflow 900 are performed by one or more processing devices, such as a computer or server. Further, workflow 900 can be performed by gates or circuits associated with a processor, Application Specific Integrated Circuit (ASIC), a field programmable gate array (FPGA), a system on chip (SOC), or other hardware device. Hereinafter, workflow 900 shall be explained with reference to the systems, components, modules, software, data structures, user interfaces, etc. described in conjunction with FIGS. 1-8.

The workflow 900 begins by collecting the most recent AMI readings (e.g., 906) for a site denoted by a specific regulatory constraint. An example includes a property with last digit address 0 restricted to weekend-only irrigation. The transmission streams raw consumption volumes from smart meters on periodic cycles such as hourly or 15-minute intervals. In examples, the data table of FIG. 4A depicts example data that may be collected as AMI readings.

The AMI data feeds can be compared at 910 to historical usage patterns 904 obtained from a historical AMI database 902 for the same location. Prior readings over past weeks establish models of expected normal indoor usage as a baseline profile distinguishing external demands. Deviations from regular trends based on day, time, or volume suggest possible activation of an irrigation system or other regulated event.

In some examples, and in parallel, applicable utility restrictions, such as but not limited to the example described in FIG. 4B, associated with the property are retrieved from a coupled regulatory database 908. Parameters can specify which days, dates, times, durations, and volumes are permitted for regulated usage per the location's policy designations. Detected demands can be checked at 910 directly against these user-specific allowances. The system automatically determines at 912 if the data indicates a regulated water event has occurred outside the allotted timeframe. For example, AMI readings may show activation of an irrigation system for 2 hours consuming 1300 gallons on a prohibited Sunday. Violation flagging is based directly on property-specific restrictions rather than simple volume thresholds.

If a non-compliant event is identified, the platform can generate a formatted notification message at 914 to the customer and/or utility staff with supporting data, such as plots, from the meter data investigation. This draft notice summarizes the suspected violation for transparent dissemination. Review by utility staff at 916 can provide quality assurance before sending to consumers.

FIG. 9 thus demonstrates automated enforcement of water regulations based on integrating user-tailored AMI measurements against encoded allowances for precision conservation independent from conventional manual oversight. Customizing permitted usage profiles beyond one-size-fits-all static limits allows collaborative achievement of usage restrictions compatible with community needs.

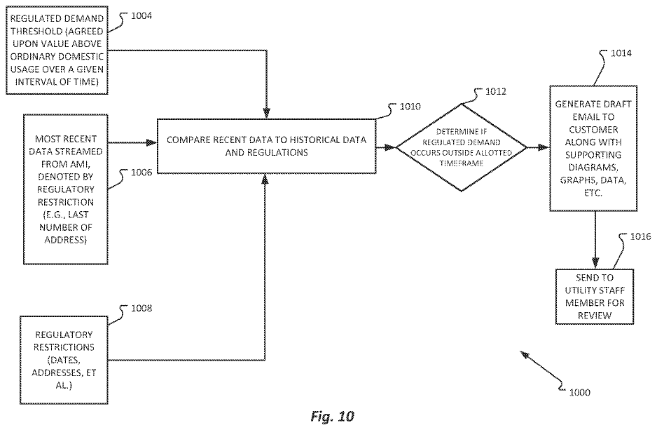

FIG. 10 depicts details of a workflow 1000 for detecting violations of water usage regulations from analysis of empirical automated meter readings relative to defined allowances in accordance with examples of the present disclosure. A general order for the steps of workflow 1000 is shown in FIG. 10. The workflow 1000 may include more or fewer steps or may arrange the order of the steps differently than those shown in FIG. 10. Workflow 1000 can be executed as a set of computer-executable instructions executed by a computer system and encoded or stored on a computer readable medium. In examples, aspects of the workflow 1000 are performed by one or more processing devices, such as a computer or server. Further, workflow 1000 can be performed by gates or circuits associated with a processor, Application Specific Integrated Circuit (ASIC), a field programmable gate array (FPGA), a system on chip (SOC), or other hardware device. Hereinafter, workflow 1000 shall be explained with reference to the systems, components, modules, software, data structures, user interfaces, etc. described in conjunction with FIGS. 1-10.

In examples, workflow 1000 shares several common stages with workflow 900 while demonstrating flexibility in detection approaches; thus, the workflow 1000 similarly starts by collecting recent usage data at 1006 from smart meters over normal short intervals like 15 minutes or hourly. Meter identifiers indicate locations denoted by a specific regulatory constraint such as permitted weekend-only irrigation. Obtaining frequent readings from across the distribution network provides regulators with near real-time visibility. In examples, the data table of FIG. 4A depicts example data that may be collected as AMI readings.

In parallel, applicable utility restrictions, such as but not limited to the example described in FIG. 4B, associated with the property are retrieved from a coupled regulatory database 1008. Parameters specify exactly which days, dates, times, durations, and volumes are permitted for regulated usage per the location's policy designations. In examples, workflow 1000 utilizes a regulated demand threshold 1004 (e.g., excess consumption threshold). This predefined volume over a timeframe is determined to be indicative of prohibited actions like irrigation activation above regular usage. As an example, 200 gallons consumed in one hour may qualify as a candidate violation event meriting investigation, whereas 200 gallons consumed over 10 hours may not warrant investigation.

Detected demands may be checked at 1010 directly against these user-specific allowances and excess consumption threshold 1004. The system automatically determines, at 1012, if the data indicates a regulated water event has occurred outside the allotted timeframe. For example, AMI readings may show activation of an irrigation system for 2 hours consuming 1300 gallons which is above an excess consumption threshold 1004 and may further be prohibited on a Sunday. Violation flagging is based directly on property-specific restrictions rather than simple volume thresholds.

If any intervals in the automated meter data exceed this threshold, the workflow 1000 can record parameters like start time, duration, and estimated excess usage for the incident. These parameters provide details regarding the suspected violation for subsequent reporting. As previously described, the quantities are directly checked at 1010 against the applicable regulatory allowances for that user at their location to determine if a true breach of policy has occurred rather than a permitted high-usage event.

As in FIG. 9, confirmed violations can result in auto-generated notifications (e.g., 1014) to consumers outlining the offense with supporting information, such as empirical data plots & metric. Prior staff review assures quality before dissemination at 1016. FIG. 10 thus illustrates an alternate streamlined violation detection approach employing standardized excess consumption thresholds. Integrating customer-oriented usage allowances ensures appropriate flexible policy enforcement beyond monolithic volume limits. The method also promotes ongoing feedback tuning over an evolving heterogeneous consumer base.

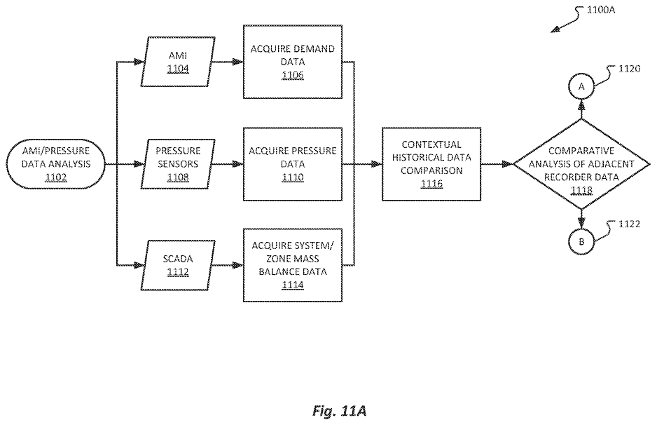

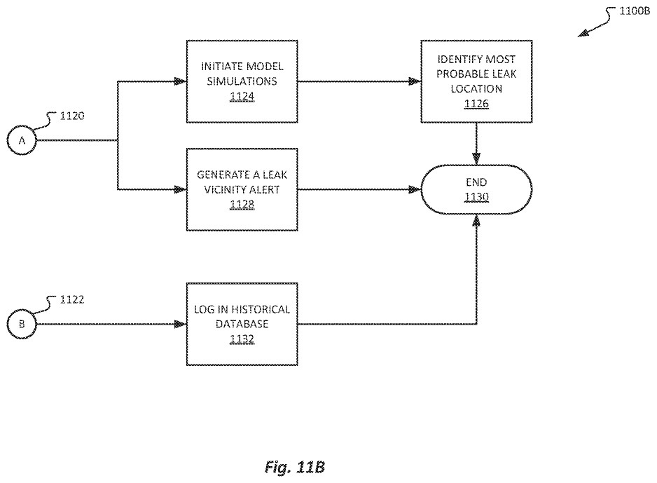

In accordance with aspects of the present disclosure, FIG. 11A and FIG. 11B illustrate a method for detecting and localizing leaks in a water distribution network. These figures depict aspects of a flowchart of processes that utilize various data sources and analytical techniques to identify potential leak locations and generate alerts. In some aspects, the method combines historical data analysis, real-time monitoring, and model simulations to provide a comprehensive approach to leak detection.

FIG. 11A illustrates the initial stages of the leak detection process, focusing on data acquisition and analysis. The process 1100A begins with AMI/pressure data analysis at 1102, which may serve as the starting point for gathering and processing relevant information from the water distribution network.

In some aspects, the AMI/pressure data analysis at 1102 initiates three parallel data acquisition streams. The first stream may involve the Advanced Metering Infrastructure (AMI) 1104, which may be responsible for collecting consumption data from individual water meters throughout the network. The AMI system provides granular usage information that can be instrumental in identifying unusual consumption patterns that may indicate leaks.

In some examples, the AMI/Pressure Data Analysis at 1102 serves as a central hub for data collection and initial analysis in the leak detection process and integrates information from multiple sources, including Advanced Metering Infrastructure (AMI), pressure sensors, and SCADA systems, to create a comprehensive picture of the water distribution network's status. In some aspects, the AMI/pressure data analysis at 1102 employs advanced algorithms to preprocess and filter incoming data, ensuring that relevant and high-quality information is passed on to subsequent stages of the analysis.

In some aspects, the AMI/pressure data analysis at 1102 may utilize machine learning techniques to identify patterns and anomalies in the incoming data streams. These techniques can adapt over time, improving the system's ability to distinguish between normal variations in water usage and potential leak indicators. In some examples, this component may also incorporate weather data and other external factors that could influence water consumption patterns, further refining its analytical capabilities. In some aspects, the AMI/pressure data analysis at 1102 may employ real-time data processing techniques to enable detection of potential leaks. This real-time analysis can trigger immediate alerts for significant anomalies, allowing for quick response to major leaks or infrastructure failures. The component may also perform batch processing of historical data to identify long-term trends and gradual changes in network behavior that could indicate developing issues.

In some examples, the AMI/pressure data analysis at 1102 may also include data visualization tools that allow operators to quickly grasp the overall state of the network. These visualizations might include color-coded maps showing pressure distributions, consumption hotspots, or areas with suspected leaks. In some examples, the component may generate automated reports summarizing key performance indicators and highlighting areas that require further investigation.

In some aspects, the AMI 1104 includes a system of one or more of smart meters, communication networks, and data management systems that work in concert to collect and transmit detailed water consumption data. These smart meters are typically installed at individual customer premises and are capable of recording water usage at frequent intervals, often as granular as hourly or even sub-hourly readings. In some examples, the AMI 1104 utilizes wireless or wired communication technologies to transmit the collected consumption data to central servers. This real-time or near-real-time data transmission enables water utilities to have up-to-date information on water usage patterns across their entire service area. The granularity and timeliness of this data are important for identifying anomalies that may indicate the presence of leaks.

The AMI 1104 may be capable of providing information that goes beyond simple volume measurements. For example, the AMI 1104 may detect flow directions, identify backflow incidents, and provide alerts for continuous flow situations, which may indicate a leak on the customer's property. In some aspects, the AMI 1104 can also record and transmit data on water pressure at the meter location, adding another layer of information for leak detection analysis. By leveraging the data from the AMI 1104, water utilities can establish baseline consumption patterns for individual customers, neighborhoods, or zones within their network. These baselines can serve as reference points against which current consumption can be compared. Significant deviations from these established patterns, especially during typically low-usage periods such as nighttime hours, can be strong indicators of potential leaks in the system.

Following the AMI 1104, the process 1100 moves to acquire demand data at 1106. In this step, the system collects and processes demand data through time for one or more connections in the network. This temporal demand data allows for the identification of consumption trends and anomalies that may be indicative of leaks or other system issues. The acquire demand data at 1106 may focus on collecting detailed water consumption information for each connection in the network over time. This process can involve aggregating data from individual AMI meters and organizing it into a structured format that facilitates analysis. In some aspects, the acquire demand data at 1106 may involve data cleaning and normalization to ensure consistency across different meter types and reading intervals. The temporal aspect of acquiring demand data (e.g., at 1106) may allow for the creation of detailed consumption profiles for each connection. These profiles can reveal patterns such as daily, weekly, or seasonal variations in water usage. In some examples, this step may also involve the calculation of derived metrics, such as moving averages or rate-of-change indicators, which can provide additional insights into consumption behavior.

In some aspects, to acquire demand data at 1106, an algorithm may include detecting and handling anomalous readings, such as negative consumption values or sudden spikes that could be due to meter malfunctions rather than actual usage changes. These data quality checks help ensure that subsequent analysis is based on reliable information. Acquiring demand data (e.g., at 1106) may also involve the integration of contextual information, such as property characteristics, customer types, or local weather conditions. This additional data can help in interpreting consumption patterns and identifying potential leaks that might be masked by expected variations in usage.

The second stream originating from the AMI/pressure data analysis 1102 involves the pressure sensors 1108. These sensors may be strategically placed throughout a water distribution network to monitor pressure levels at various points and to provide a comprehensive view of pressure variations. The pressure data collected by these sensors can provide insights into the hydraulic behavior of the system. Pressure sensor 1108 may play a role in monitoring the hydraulic state of the water distribution network. In some aspects, the pressure sensors 1108 may include both fixed sensors permanently installed at key points in the network and mobile sensors that can be deployed temporarily to investigate specific areas of concern.

The pressure sensors 1108 may utilize various technologies, such as piezoelectric or strain gauge sensors, to accurately measure water pressure. In some examples, these sensors may be equipped with data logging capabilities, allowing them to store pressure readings over extended periods. This feature can be particularly useful in areas with limited communication infrastructure or when conducting targeted investigations. In some aspects, the pressure sensors 1108 may be part of a larger Internet of Things (IoT) ecosystem within the water distribution network. This integration may allow for real-time monitoring and rapid response to pressure anomalies that could indicate leaks or other system issues.

The data from pressure sensors 1108 can be used to create detailed pressure maps of the distribution network, helping operators visualize pressure zones and identify areas of potentially excessive or insufficient pressure. In some examples, these sensors may also be equipped with additional capabilities, such as water quality monitoring, providing a more comprehensive view of the network's overall health.

After the pressure sensors 1108, the process 1100A process proceeds to acquire pressure data at 1110. In this step, the system gathers pressure data through time where available. The temporal pressure data allows for the analysis of pressure fluctuations and anomalies that may be associated with leaks or other system disturbances. In some aspects, to acquire pressure data at 1110 may involve the collection and processing of pressure readings from the network of sensors. In some aspects, acquiring pressure data (e.g., at 1110) may involve real-time data streaming from sensors equipped with communication capabilities, enabling immediate detection of pressure anomalies that could indicate leaks. The temporal nature of the acquiring pressure data (e.g., at 1110) may allow for the creation of pressure profiles for different zones within the network. These profiles can reveal patterns such as diurnal pressure variations and the impact of system operations on pressure levels. In some examples, this step may also involve data validation and error correction to ensure the accuracy of the pressure readings used in subsequent analysis.

In some aspects, acquiring pressure data (e.g., at 1110) may include algorithms for detecting sudden pressure drops or unusual fluctuations that could indicate the presence of a leak. These algorithms may take into account factors such as normal operational changes, pump schedules, and known system characteristics to distinguish between expected pressure variations and those that warrant further investigation. Acquiring pressure data (e.g., at 1110) may also involve the integration of pressure data with other system information, such as flow rates and valve positions. This integrated approach can provide a more comprehensive understanding of the network's hydraulic state and improve the accuracy of leak detection analyses.

A third stream from the AMI/pressure data analysis 1102 involves the Supervisory Control and Data Acquisition (SCADA) system 1112. SCADA systems can be used to monitor and control various aspects of the water distribution network, providing a comprehensive view of the system's operational status. The SCADA system 1112 can serve as the nerve center for monitoring and controlling the water distribution network. The SCADA system 1112 may collect data from various sensors and control devices throughout the system, providing operators with a real-time overview of network status. In some aspects, the SCADA system 1112 may incorporate advanced visualization tools, allowing operators to quickly identify and respond to anomalies in the network.

The SCADA system 1112 may also play a role in automating certain aspects of network operation, such as adjusting pump speeds or valve positions to maintain optimal pressure levels. In some examples, the SCADA system 1112 may include predictive maintenance capabilities, using historical data to forecast potential equipment failures and schedule preventive maintenance activities. In some aspects, the SCADA system 1112 may serve as a central repository for all operational data, including flow rates, pressure readings, water quality parameters, and equipment status. This centralized data storage can facilitate comprehensive analysis and reporting, supporting both day-to-day operations and long-term planning efforts. The SCADA system 1112 may also include advanced security features to protect against cyber threats and unauthorized access. In some examples, it may employ redundant systems and backup power sources to ensure continuous operation even in the event of equipment failures or power outages.

Following the SCADA system 1112, the process 1100A moves to acquire system/zone mass balance data at 1114. In this stage, the system may collect mass balance data for specific zones or the entire system through time where available. Mass balance data can help identify discrepancies between water input and output, which may indicate the presence of leaks. In some aspects, acquiring system/zone mass balance data 1114 may involve collecting and analyzing data to perform mass balance calculations for specific zones or the entire water distribution system. This process works to identify discrepancies between water input and output that could indicate the presence of leaks. In some aspects, acquiring system/zone mass balance data 1114 may involve integrating data from multiple sources, including flow meters at water treatment plants, pump stations, and zone boundaries.

The temporal nature of acquiring system/zone mass balance data 1114 allows for the creation of detailed water balance profiles over time. These profiles can reveal trends in water loss and help identify areas of the network that may require closer investigation. In some examples, this step may also involve the calculation of performance indicators, such as Infrastructure Leakage Index (ILI) or Non-Revenue Water (NRW) percentages, which provide standardized metrics for assessing system efficiency.

In some aspects, acquiring system/zone mass balance data 1114 may include algorithms for detecting and quantifying various components of water loss, such as apparent losses (e.g., meter inaccuracies, unauthorized consumption) and real losses (e.g., leaks, overflows). This detailed breakdown can help utilities prioritize their water loss reduction efforts and allocate resources more effectively. Acquiring system/zone mass balance data 1114 may also involve the use of advanced statistical techniques to account for uncertainties in measurements and estimations. In some examples, this may include Monte Carlo simulations or other probabilistic methods to provide confidence intervals for water loss estimates.

After acquiring data from these three streams, the process 1100A proceeds to perform contextual historical data comparisons at 1116. In this step, the system compares the most recent readings with historical conditions that are most similar. This comparison allows for the identification of deviations from expected behavior based on past performance under similar conditions. Performing contextual historical data comparisons at 1116 may involve the analysis of current network conditions in the context of historical data. This comparison allows for the identification of anomalies that deviate from expected behavior based on past performance under similar conditions. In some aspects, performing contextual historical data comparisons at 1116 may utilize advanced pattern recognition algorithms to identify subtle changes in network behavior that could indicate the presence of leaks.

The historical data used in this comparison may include a wide range of parameters, such as consumption patterns, pressure profiles, and weather conditions. In some examples, performing contextual historical data comparisons at 1116 may employ machine learning techniques to continuously refine its understanding of normal network behavior, improving its ability to detect anomalies over time. In some aspects, performing contextual historical data comparisons at 1116 may include the creation of dynamic baseline models that adapt to long-term changes in network characteristics or consumption patterns. These adaptive models can help distinguish between gradual shifts in system behavior and sudden anomalies that may indicate leaks. In some aspects, performing contextual historical data comparisons at 1116 may also involve the use of time series analysis techniques, such as seasonal decomposition or Fourier analysis, to identify periodic patterns and trends in the data. In some examples, this analysis may be performed at multiple time scales to capture both short-term fluctuations and long-term trends.

The final step in FIG. 11A involves the comparative analysis of adjacent recorder data at 1118. In some aspects, such an analysis may determine if a number of recorders (e.g., 10) at adjacent locations are receiving less water under similar pressure and system-wide demand conditions. This step helps identify localized anomalies that may indicate the presence of a leak. The comparative analysis of adjacent recorder data at 1118 may involve examining data from multiple recorders in close proximity to identify localized anomalies that may indicate the presence of a leak. This analysis can consider factors such as water consumption, pressure levels, and overall system demand to determine if a group of adjacent recorders is exhibiting unusual behavior. In some aspects, this step may utilize spatial analysis techniques to identify clusters of recorders showing similar anomalous patterns.

In some examples, a threshold of “10 recorders” is an example of the scale at which this analysis can be performed. In some examples, the comparative analysis of adjacent recorder data at 1118 may employ adaptive thresholds that adjust based on the specific characteristics of different network zones, ensuring that the analysis is sensitive to local conditions while minimizing false positives. In some aspects, the comparative analysis of adjacent recorder data at 1118 may incorporate geospatial analysis techniques to account for the physical layout of the network and the spatial relationships between recorders. This can help in identifying patterns that may not be apparent when looking at individual recorder data in isolation. The comparative analysis of adjacent recorder data at 1118 may also involve the use of statistical clustering algorithms to group recorders with similar behavior. In some examples, this clustering approach can help in identifying sub-zones within the network that may be experiencing similar issues, such as pressure problems or localized leaks.

The “Yes” 1120 and “No” 1122 decision points represent the branching of the process based on the outcome of the comparative analysis of adjacent recorder data at 1118. A “Yes” outcome indicates that the analysis has detected a potential leak, triggering further investigation and response actions. A “No” outcome suggests that no significant anomalies were detected, leading to the logging of the analysis results for future reference. In some aspects, the decision process at these points may involve more than a simple binary outcome. For example, there may be a confidence score associated with the detection, allowing for different levels of response based on the likelihood of a leak.

The decision points may also trigger different workflows depending on the specific characteristics of the detected anomaly. For instance, a high-confidence detection might initiate an urgent field investigation, while a lower-confidence result might prompt additional data gathering or analysis. In some examples, the decision process at these points may incorporate feedback mechanisms that allow the system to learn from past outcomes, continuously improving its decision-making accuracy over time.

Moving to FIG. 11B, the flowchart continues with two possible paths based on the outcome of the comparative analysis of adjacent recorder data at 1118. If the analysis yields a positive result (e.g., 1120), indicating a potential leak, the process branches into two parallel actions. In some examples, one branch leads to initiate model simulations at 1124. In this step, the system triggers model simulations of potential leaks based on the observed conditions. These simulations help predict the behavior of the network under various leak scenarios, aiding in the localization of the actual leak. In some aspects, initiating model simulations (e.g., at 1124) involves running hydraulic model simulations to predict network behavior under various leak scenarios. These simulations help in localizing the potential leak by comparing modeled outcomes with observed data. In some aspects, initiating model simulations (e.g., at 1124) may utilize advanced computational techniques, such as parallel processing or cloud computing, to run multiple simulations quickly and efficiently.

The model simulations may incorporate a wide range of parameters, including network topology, pipe characteristics, and historical consumption patterns. In some examples, initiating model simulations (e.g., at 1124) may employ ensemble modeling techniques, running multiple simulations with slightly different parameters to account for uncertainties in the input data and model assumptions. In some aspects, initiating model simulations (e.g., at 1124) may include real-time calibration of the hydraulic model based on current network conditions. This dynamic calibration can improve the accuracy of the simulations by ensuring that the model closely reflects the actual state of the network at the time of the suspected leak. In some aspects, initiating model simulations (e.g., at 1124) may also involve the use of optimization algorithms to efficiently explore the space of possible leak scenarios. In some examples, this may include the use of genetic algorithms or other heuristic methods to quickly identify the most probable leak locations based on the simulation results.

Following the model simulations, the process 1100 may move to identify a most probable leak location at 1126. In this stage, the system analyzes the simulation results to determine the most likely location of the leak based on the observed data and simulated scenarios. This step narrows down the search area for field teams to investigate, improving the efficiency of leak detection and repair efforts. In some aspects, identifying the most probably leak location (e.g., at 1126) may involve analyzing the results of the model simulations to determine the most likely location of the leak based on the observed data and simulated scenarios.

In some aspects, to identify the most probably leak location (e.g., at 1126), one or more probabilistic methods may be used to rank potential leak locations based on their likelihood. This ranking can help prioritize field investigations and allocate resources more effectively. The identification process may also take into account practical considerations, such as the accessibility of different parts of the network or the potential impact of a leak in various locations. In some examples, this may involve integrating GIS data to provide additional context for the identified locations. In some aspects, identifying the most probably leak location (e.g., at 1126) may include the generation of detailed reports or visualizations to support decision-making by utility operators. These outputs might include maps highlighting the most probable leak areas, confidence intervals for different locations, or recommendations for follow-up actions.

The other branch from the positive result (e.g., 1120) leads to generating a leak vicinity alert at 1128. In this step, the system generates an alert indicating that a leak is likely occurring in the vicinity of the identified addresses. This alert can be sent to relevant personnel for immediate action. In some aspects, generating a leak vicinity alert (e.g., at 1128) may involve creating and disseminating notifications about the potential presence of a leak in a specific area based on an analysis of historical demand/pressure data and providing more location precision than an alert that a leak may be occurring at the pressure zone/DMA/system-wide level. These alerts can be sent to relevant personnel, such as field technicians or network operators, to prompt further investigation or immediate action. In some aspects, generating a leak vicinity alert (e.g., at 1128) may include the automatic prioritization of alerts based on factors such as the estimated leak size, potential impact on service, or proximity to critical infrastructure. This prioritization helps ensure that the most urgent situations receive immediate attention.

The alert generation process may also include the compilation of relevant contextual information to support the response team. In some examples, this might include recent maintenance history for the area, known network vulnerabilities, or specific access instructions for the suspected leak location. In some aspects, generating a leak vicinity alert (e.g., at 1128) may incorporate multiple communication channels to ensure timely notification. This could include automated SMS messages, email alerts, push notifications to mobile devices, or integration with existing work order management systems.

If the comparative analysis of adjacent recorder data at 1118 yields a negative result (e.g., 1122), indicating no potential leak detected, the process moves to log into a historical database at 1132. In this step, the system records the analyzed data and results in a historical database for future reference and analysis. In some aspects, logging information into the historical database at 1132 may involve recording the results of the current analysis cycle, including all relevant data, decisions made, and actions taken. This logging process is crucial for maintaining a comprehensive record of system performance and supporting long-term trend analysis.

In some aspects, In some aspects, logging information into the historical database at 1132 may involve data management techniques to efficiently store and index large volumes of time-series data. This might include the use of specialized database systems designed for handling high-velocity, high-volume data streams. The logging process may also include the creation of various data aggregations or summaries to support different types of historical analysis. In some examples, this might involve calculating daily, weekly, or monthly statistics for key performance indicators. In some aspects, logging information into the historical database at 1132 may incorporate data retention policies that balance the need for historical records with storage constraints. This might involve implementing data archiving strategies or employing data compression techniques to manage long-term storage efficiently.

Both branches of the flowchart, regardless of the initial outcome, may conclude at the end 1130 step, signifying the completion of the leak detection and analysis process for the current cycle. The end 1130 step represents the completion of the current cycle of the leak detection and analysis process. It signifies that all necessary actions for the current iteration have been taken, whether that involves initiating a response to a detected leak or logging the results of a normal analysis. In some aspects, the end 1130 step may trigger a series of wrap-up actions, such as generating summary reports of the analysis cycle, updating performance metrics, or scheduling the next iteration of the leak detection process. The end 1130 step may also serve as a checkpoint for system health checks, ensuring that all components of the leak detection system are functioning correctly before beginning the next cycle. In some examples, this may involve running diagnostic tests or performing routine maintenance tasks. In some aspects, the end 1130 step may include a feedback loop that allows the system to learn from the current cycle's outcomes, potentially adjusting parameters or thresholds to improve future leak detection performance.

Aspects of the present disclosure provide apparatuses, methods, processing systems, and computer-readable mediums for detecting and localizing leaks in water distribution networks using advanced data analysis and hydraulic modeling techniques. The present disclosure describes a comprehensive leak detection system that integrates multiple data sources, including pressure sensors, Advanced Metering Infrastructure (AMI), and Supervisory Control and Data Acquisition (SCADA) systems. This integrated approach allows for a holistic analysis of the water distribution network, combining real-time monitoring with historical data analysis and hydraulic simulations to identify and locate potential leaks with high accuracy.

Water utilities face significant challenges in detecting and localizing leaks within their distribution networks. Traditional methods often rely on manual inspections or simplistic threshold-based alerts, which can be time-consuming, inefficient, and prone to false positives. Moreover, the complex nature of water distribution networks, with their varying demand patterns and pressure zones, makes it difficult to distinguish between normal operational fluctuations and actual leaks.

The technical solution provided by the present disclosure involves a multi-step analysis process that leverages advanced data processing techniques and hydraulic modeling. The system performs contextual historical data comparisons, actual versus expected head conditions analysis, and comparative analysis of adjacent recorder data. When potential anomalies are detected, the system initiates targeted hydraulic model simulations to pinpoint the most probable leak locations. This approach allows for a more nuanced and accurate detection of leaks, taking into account the dynamic nature of water distribution networks.

The benefits of this technical solution are numerous. By integrating multiple data sources and employing advanced analysis techniques, the system significantly reduces false positives and improves the accuracy of leak detection. The use of hydraulic and advanced data modeling for leak localization minimizes the time and resources required for field investigations. Furthermore, the system's ability to analyze data in real-time enables rapid response to potential leaks, reducing water loss and potential infrastructure damage. The adaptive nature of the system, which learns from historical data and past leak events, allows for continuous improvement in detection accuracy over time. This comprehensive approach not only enhances operational efficiency for water utilities but also contributes to water conservation efforts by enabling prompt identification and repair of leaks.

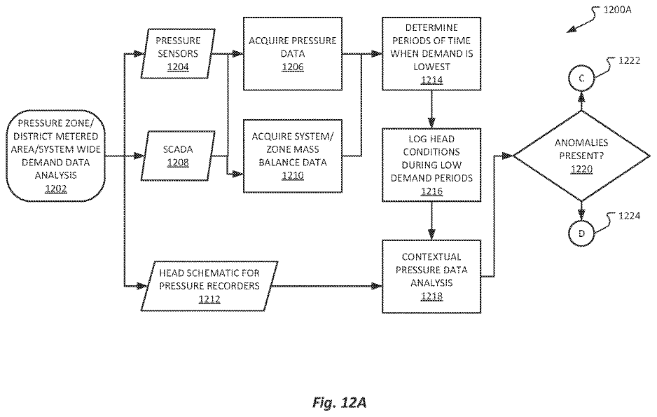

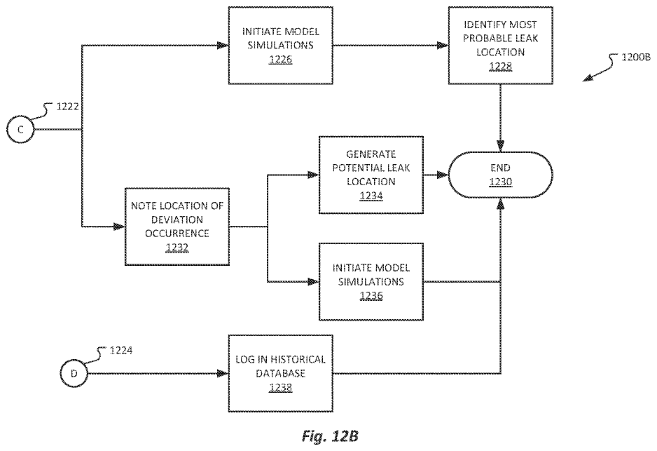

In accordance with aspects of the present disclosure, FIG. 12A and FIG. 12B illustrate a method for detecting and localizing leaks in a water distribution network. These figures depict an example flowchart of processes that utilize various data sources and analytical techniques to identify potential leak locations and generate alerts. The method may combine real-time monitoring, historical data analysis, and model simulations to provide a comprehensive approach to leak detection.

FIG. 12A illustrates the initial stages of the leak detection process, focusing on data acquisition and analysis. The process begins with a pressure/system-wide demand data analysis at 1202, which may serve as a starting point for gathering and processing relevant information from the water distribution network. In some aspects, performing the pressure/system-wide demand data analysis at 1202 may initiate multiple parallel data acquisition streams. A pressure/system-wide demand data analysis at 1202 may integrate information from various sources to create a comprehensive picture of the water distribution network's status. In some examples, it may employ advanced algorithms to preprocess and filter incoming data, ensuring that only relevant and high-quality information is passed on to subsequent stages of the analysis.

In some aspects, the pressure/system-wide demand data analysis at 1202 may utilize machine learning techniques to identify patterns and anomalies in the incoming data streams. These techniques can adapt over time, improving the system's ability to distinguish between normal variations in water usage and potential leak indicators. In some aspects, this component may also incorporate weather data and other external factors that could influence water consumption patterns, further refining its analytical capabilities.

Pressure sensors 1204 may be capable of monitoring the hydraulic state of the water distribution network. These sensors can be strategically placed throughout the system to provide a comprehensive view of pressure variations. In some aspects, the pressure sensors 1204 may include both fixed sensors permanently installed at key points in the network and mobile sensors that can be deployed temporarily to investigate specific areas of concern. The pressure sensors 1204 may utilize various technologies, such as piezoelectric or strain gauge sensors, to accurately measure water pressure. In some examples, these sensors may be equipped with data logging capabilities, allowing them to store pressure readings over extended periods. This feature can be particularly useful in areas with limited communication infrastructure or when conducting targeted investigations. In some aspects, the pressure sensors 1204 may be part of a larger Internet of Things (IoT) ecosystem within the water distribution network. This integration allows for real-time monitoring and rapid response to pressure anomalies that could indicate leaks or other system issues.

In some aspects, acquiring pressure data at 1206 may involve the collection and processing of pressure readings from the network of sensors. In some aspects, acquiring pressure data at 1206 may involve obtaining real-time data streaming from sensors equipped with communication capabilities, enabling immediate detection of pressure anomalies that could indicate leaks. The temporal nature of acquiring pressure data at 1206 allows for the creation of pressure profiles for different zones within the network. These profiles can reveal patterns such as diurnal pressure variations and the impact of system operations on pressure levels. In some examples, acquiring pressure data at 1206 may also involve data validation and error correction to ensure the accuracy of the pressure readings used in subsequent analysis. In some aspects, acquiring pressure data at 1206 may include algorithms for detecting sudden pressure drops or unusual fluctuations that could indicate the presence of a leak. These algorithms may take into account factors such as normal operational changes, pump schedules, and known system characteristics to distinguish between expected pressure variations and those that warrant further investigation.

The SCADA system 1208 serves as the nerve center for monitoring and controlling the water distribution network. In some aspects, the SCADA system 1208 collects data from various sensors and control devices throughout the system, providing operators with a real-time overview of network status. In some aspects, the SCADA system 1208 may incorporate advanced visualization tools, allowing operators to quickly identify and respond to anomalies in the network.

The SCADA system 1208 may also play a role in automating certain aspects of network operation, such as adjusting pump speeds or valve positions to maintain optimal pressure levels. In some examples, the SCADA system 1208 may include predictive maintenance capabilities, using historical data to forecast potential equipment failures and schedule preventive maintenance activities. In some aspects, the SCADA system 1208 may serve as a central repository for all operational data, including flow rates, pressure readings, water quality parameters, and equipment status. This centralized data storage facilitates comprehensive analysis and reporting, supporting both day-to-day operations and long-term planning efforts.

In some aspects, acquiring system/zone mass balance data at 1210 may involve collecting and analyzing data to perform mass balance calculations for specific zones or the entire water distribution system. This process can be used to identify discrepancies between water input and output that could indicate the presence of leaks. In some aspects, acquiring system/zone mass balance data at 1210 may involve integrating data from multiple sources, including flow meters at water treatment plants, pump stations, and zone boundaries. The temporal nature of acquiring system/zone mass balance data at 1210 allows for the creation of detailed water balance profiles over time. These profiles can reveal trends in water loss and help identify areas of the network that may require closer investigation. In some examples, this step may also involve the calculation of performance indicators, such as Infrastructure Leakage Index (ILI) or Non-Revenue Water (NRW) percentages, which provide standardized metrics for assessing system efficiency. In some aspects, acquiring system/zone mass balance data at 1210 may utilize one or more algorithms for detecting and quantifying various components of water loss, such as apparent losses (e.g., meter inaccuracies, unauthorized consumption) and real losses (e.g., leaks, overflows). This detailed breakdown can help utilities prioritize their water loss reduction efforts and allocate resources more effectively.

In some aspects, the head schematic for pressure recorders 1212 may provide a visual representation of the pressure distribution across the network. In some aspects, this schematic aids in understanding the hydraulic profile of the system and can be instrumental in identifying anomalies that may indicate leaks. In some aspects, the head schematic for pressure recorders 1212 may be dynamically updated based on real-time data from pressure sensors. This allows operators to visualize pressure changes across the network as they occur, facilitating rapid detection of unusual patterns or sudden drops that could signify a leak. The head schematic for pressure recorders 1212 may also incorporate color-coding or other visual cues to highlight areas of the network experiencing pressure levels outside of normal operating ranges. In some examples, this component may allow for interactive exploration of the pressure data, enabling operators to zoom in on specific areas of interest or compare current pressure profiles with historical data.

In some aspects, determining periods of time when demand is lowest at 1214 may involve analyzing consumption data to identify timeframes when water usage in the network is at its minimum. These periods, often occurring during nighttime hours, provide optimal conditions for detecting leaks, as the background noise from normal consumption is reduced. In some aspects, statistical analysis techniques to identify consistent patterns of low demand across different days of the week or seasons may be used to determine periods of time when demand is lowest at 1214. This analysis can help in scheduling automated leak detection routines during the most favorable times. The determination of low demand periods may also take into account factors such as local events, holidays, or other circumstances that might affect typical usage patterns. In some examples, this step may involve machine learning algorithms that can adapt to changing consumption patterns over time, ensuring that the identified low demand periods remain accurate and relevant.

In some aspects, method 1200A may proceed to log head conditions during low demand periods at 1216, which may involve recording pressure and hydraulic profile data from various sensors during the identified periods of minimal water usage. This data provides a baseline for normal system behavior under low-flow conditions, which can be used for comparison to detect anomalies that may indicate leaks. In some aspects, logging head conditions during low demand periods at 1216 may include advanced data logging techniques that capture not only pressure readings but also other relevant parameters such as flow rates or water quality indicators. This comprehensive data collection can provide a more complete picture of system behavior during low demand periods. The logged data may be stored with high temporal resolution, allowing for detailed analysis of pressure fluctuations even during short-duration events. In some examples, this step may also involve automatic flagging of unusual readings or patterns for further investigation, streamlining the leak detection process.

In some aspects, a contextual pressure data analysis 1218 may be performed and may involve comparing current pressure readings at each sensor location with historical data from similar demand conditions. This analysis helps identify deviations from expected pressure patterns that could indicate the presence of a leak. In some aspects, the contextual pressure data analysis 1218 may employ machine learning algorithms to recognize complex patterns in the pressure data that might not be apparent through simple threshold-based comparisons. These algorithms can learn from historical data to improve their accuracy in distinguishing between normal pressure variations and those indicative of leaks The contextual analysis may also take into account external factors that could affect pressure readings, such as weather conditions or planned network operations. In some examples, this step may involve the use of advanced statistical techniques, such as time series analysis or Bayesian inference, to quantify the likelihood of a leak based on observed pressure deviations.

In some aspects, a decision point (e.g., anomalies present 1220) represents a juncture in the leak detection process where the system determines whether the analyzed data indicates the presence of potential leaks. This decision is based on the results of the contextual pressure data analysis and other relevant information gathered in previous steps. In some aspects, to determine if an anomaly is present, a scoring system that quantifies the likelihood of a leak based on multiple factors, rather than a simple binary yes/no determination may be used. This nuanced approach can help prioritize follow-up actions based on the severity and confidence level of detected anomalies. The decision-making process at this point may also incorporate historical performance data to adjust its sensitivity over time. In some examples, machine learning techniques could be employed to continuously refine the criteria for anomaly detection, improving the system's accuracy in distinguishing between true leaks and false positives.

The “C” (e.g., 1222) and “D” (e.g., 1224) connectors in FIG. 12A link to corresponding points in FIG. 12B, indicating the flow of the process based on whether anomalies are detected or not. These connectors help to ensure a logical progression of the leak detection workflow across the two diagrams.

FIG. 12B illustrates the subsequent steps in the leak detection process, focusing on leak localization and response actions. The figure shows two main paths: one for when anomalies are detected (starting from connector “C”) and another for when no anomalies are found (starting from connector “D”).

In some aspects, initiating model simulations at 1126 may involve running hydraulic model simulations to predict network behavior under various leak scenarios. These simulations help in localizing the potential leak by comparing modeled outcomes with observed data. In some aspects, initiating model simulations at 1126 may utilize advanced computational techniques, such as parallel processing or cloud computing, to run multiple simulations quickly and efficiently. This allows for the exploration of a wide range of possible leak scenarios in a short time frame. The model simulations may incorporate a wide range of parameters, including network topology, pipe characteristics, and historical consumption patterns. In some examples, initiating model simulations at 1126 may employ ensemble modeling techniques, running multiple simulations with slightly different parameters to account for uncertainties in the input data and model assumptions.

In some aspects, the identification of the most probable leak location at 1228 may involve analyzing the results of the model simulations to determine the most likely location of the leak based on the observed data and simulated scenarios. This process can be used to narrow down the search area for field teams to investigate, improving the efficiency of leak detection and repair efforts. In some aspects, identifying the most probable leak location at 1228 may involve one or more probabilistic methods to rank potential leak locations based on their likelihood. This ranking can help prioritize field investigations and allocate resources more effectively. The identification process may also take into account practical considerations, such as the accessibility of different parts of the network or the potential impact of a leak in various locations. In some examples, this may involve integrating GIS data to provide additional context for the identified locations.

The end 1230 step represents the completion of the current cycle of the leak detection and analysis process. It signifies that all necessary actions for the current iteration have been taken, whether that involves initiating a response to a detected leak or logging the results of a normal analysis. In some aspects, the end 1230 step may trigger a series of wrap-up actions, such as generating summary reports of the analysis cycle, updating performance metrics, or scheduling the next iteration of the leak detection process. The end 1230 step may also serve as a checkpoint for system health checks, ensuring that all components of the leak detection system are functioning correctly before beginning the next cycle. In some examples, this may involve running diagnostic tests or performing routine maintenance tasks.

In some aspects, the location of the deviation occurrence may be noted at 1232. In some aspects, noting the location of the deviation occurrence (e.g., at 1232) may involve recording the specific locations within the network where pressure or flow deviations were detected. This information can be used to focus subsequent analysis and field investigations on the most relevant areas. In some aspects, noting the location of the deviation occurrence (e.g., at 1232) may involve creating detailed geospatial records of the anomalies, including not just the location but also the magnitude and duration of the observed deviations. This comprehensive recording can aid in pattern recognition across multiple detection cycles. The noted locations may be prioritized based on the severity of the deviations or their potential impact on the network. In some examples, this step may also involve correlating the deviation locations with other relevant data, such as pipe age, maintenance history, or previous leak incidents in the area.

Generating a potential leak location at 1234 may involve using the noted deviation locations and other relevant data to identify specific areas within the network where leaks are most likely to be present. This process helps to further narrow down the search area for field investigations. In some aspects, generating the potential leak location at 1234 may involve using advanced spatial analysis techniques to consider factors such as network topology, pipe materials, and historical leak patterns in determining the most probable leak locations. This can include the use of machine learning algorithms trained on historical leak data to improve prediction accuracy. The generation of potential leak locations may also involve a risk assessment component, evaluating the potential consequences of leaks in different areas of the network. In some examples, this step may produce a prioritized list of locations for investigation, taking into account both the likelihood of a leak and its potential impact.

In some aspects, one or more model simulations may be initiated at 1236. In some aspects, initiating one or more model simulations at 1236 may involve running detailed hydraulic simulations focused on the specific areas identified as potential leak locations. These simulations help to further refine the leak localization process by modeling the network behavior under various leak scenarios in these targeted areas. In some aspects, initiating one or more model simulations at 1236 may utilize high-resolution models of the network, incorporating detailed information about pipe characteristics, junction configurations, and local demand patterns. This level of detail allows for more accurate predictions of leak impacts on the surrounding infrastructure. The simulations may explore a range of leak sizes and types, helping to characterize the nature of the potential leak as well as its location. In some examples, this step may also involve simulating the effectiveness of different leak detection technologies or methods in the specific network context, aiding in the selection of appropriate field investigation techniques.

In some aspects, results may be logged in a historical database at 1238. In some aspects, logging the result in the historical database at 1238 may involve recording the results of the current analysis cycle, including relevant data, decisions made, and actions taken. This logging process helps to maintain a comprehensive record of system performance and supports long-term trend analysis. In some aspects, logging the result in the historical database at 1238 may involve sophisticated data management techniques to efficiently store and index large volumes of time-series data. This might include the use of specialized database systems designed for handling high-velocity, high-volume data streams. The logging process may also include the creation of various data aggregations or summaries to support different types of historical analysis. In some examples, this might involve calculating daily, weekly, or monthly statistics for key performance indicators, facilitating long-term performance monitoring and trend identification.

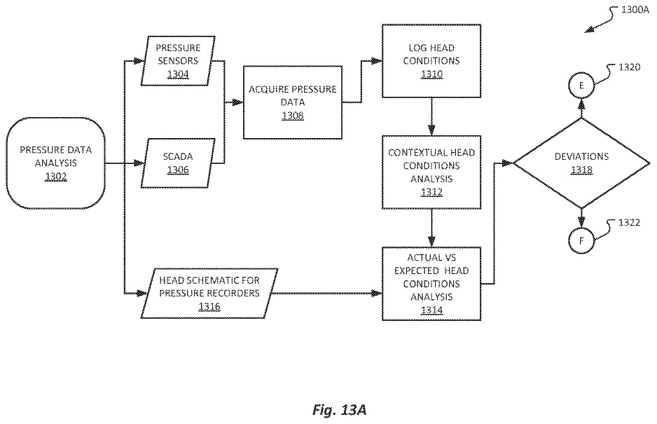

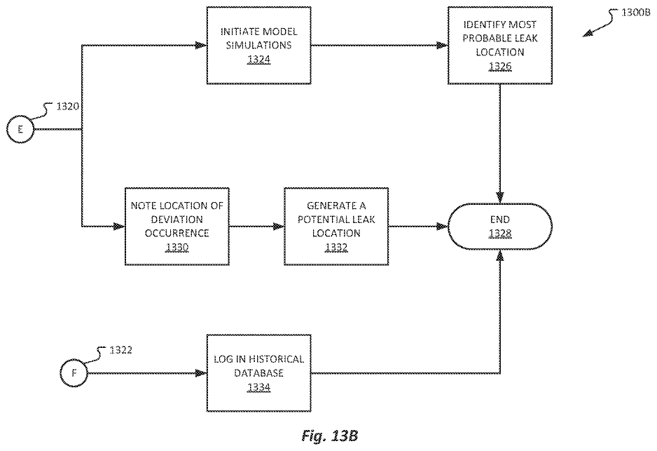

In accordance with aspects of the present disclosure, FIG. 13A and FIG. 13B illustrate a method for detecting and localizing leaks in a water distribution network using pressure data analysis and hydraulic modeling. These figures depict example flowcharts of processes that utilize various data sources, analytical techniques, and simulation methods to identify potential leak locations and generate alerts. The method can combine real-time monitoring, historical data analysis, and model simulations to provide a comprehensive approach to leak detection.

FIG. 13A illustrates the initial stages of the leak detection process, focusing on pressure data acquisition and analysis. The process begins with a pressure data analysis at 1302, which may serve as a starting point for gathering and processing relevant pressure information from the water distribution network. In some aspects, the pressure data analysis at 1302 may initiate multiple parallel data acquisition streams. The pressure data analysis at 1302 may integrate pressure information from various sources to create a comprehensive picture of the water distribution network's hydraulic state. In some examples, the pressure data analysis may employ advanced algorithms to preprocess and filter incoming pressure data, ensuring that only relevant and high-quality information is passed on to subsequent stages of the analysis. The pressure data analysis at 1302 may utilize machine learning techniques to identify patterns and anomalies in the incoming pressure data streams. These techniques can adapt over time, improving the system's ability to distinguish between normal pressure variations and potential leak indicators. In some aspects, this component may also incorporate external factors that could influence pressure patterns, such as pump operations or valve settings, further refining its analytical capabilities.

Pressure sensor 1304 may monitor the hydraulic state of the water distribution network. These sensors may be strategically placed throughout the system to provide a comprehensive view of pressure variations. In some aspects, the pressure sensors 1304 may include both fixed sensors permanently installed at key points in the network and mobile sensors that can be deployed temporarily to investigate specific areas of concern. The pressure sensors 1304 may utilize various technologies, such as piezoelectric or strain gauge sensors, to accurately measure water pressure. In some examples, these sensors may be equipped with data logging capabilities, allowing them to store pressure readings over extended periods. This feature can be particularly useful in areas with limited communication infrastructure or when conducting targeted investigations. In some aspects, the pressure sensors 1304 may be part of a larger Internet of Things (IoT) ecosystem within the water distribution network. This integration allows for real-time monitoring and rapid response to pressure anomalies that could indicate leaks or other system issues. The data from these sensors forms the foundation for subsequent analysis and leak detection processes.

The SCADA system 1306 serves as the nerve center for monitoring and controlling the water distribution network. It collects data from various sensors and control devices throughout the system, providing operators with a real-time overview of network status, including pressure readings. In some aspects, the SCADA system 1306 may incorporate advanced visualization tools, allowing operators to quickly identify and respond to pressure anomalies in the network. The SCADA system 1306 may also play a role in automating certain aspects of network operation, such as adjusting pump speeds or valve positions to maintain optimal pressure levels. In some examples, the SCADA system 1306 may include predictive maintenance capabilities, using historical pressure data to forecast potential equipment failures and schedule preventive maintenance activities. In some aspects, the SCADA system 1306 may serve as a central repository for all operational data, including pressure readings, flow rates, water quality parameters, and equipment status. This centralized data storage facilitates comprehensive analysis and reporting, supporting both day-to-day operations and long-term planning efforts related to pressure management and leak detection.

In some aspects, pressure data may be acquired at 1308. Acquiring pressure data at 1308 may involve the collection and processing of pressure readings from the network of sensors. In some aspects, acquiring pressure data at 1308 may involve using real-time data streaming from sensors equipped with communication capabilities, enabling immediate detection of pressure anomalies that could indicate leaks. The temporal nature of the acquiring pressure data allows for the creation of pressure profiles and hydraulic grade using elevation for different zones within the network. These profiles can reveal patterns such as diurnal pressure variations and the impact of system operations on pressure levels. In some examples, this step may also involve data validation and error correction to ensure the accuracy of the pressure readings used in subsequent analysis. In some aspects, acquiring pressure data at 1308 may include using algorithms for detecting sudden pressure drops or unusual fluctuations that could indicate the presence of a leak. These algorithms may take into account factors such as normal operational changes, pump schedules, and known system characteristics to distinguish between expected pressure variations and those that warrant further investigation.

In some aspects, the head conditions may be logged at 1310. Logging head conditions at 1310 may involve recording pressure data, often expressed as hydraulic head, from various sensors throughout the network. This data can provide a snapshot of the system's hydraulic state at specific points in time, which can be used for comparison and analysis to detect potential leaks. In some aspects, logging head conditions at 1310 may include advanced data logging techniques that capture not only pressure readings but also other relevant parameters such as flow rates or water quality indicators. This comprehensive data collection can provide a more complete picture of system behavior and aid in the identification of anomalies that may indicate leaks. The logged data may be stored with high temporal resolution, allowing for detailed analysis of pressure fluctuations even during short-duration events. In some examples, this step may also involve automatic flagging of unusual readings or patterns for further investigation, streamlining the leak detection process. The logged head conditions serve as an important input for subsequent analysis steps in the leak detection workflow.

In some aspects, a contextual head conditions analysis may be performed at 1312. In some aspects, performing a contextual head conditions analysis at 1312 may involve comparing current pressure readings at each sensor location with historical data from similar demand conditions. This analysis helps identify deviations from expected pressure patterns that could indicate the presence of a leak. In some aspects, performing a contextual head conditions analysis at 1312 may utilize one or more machine learning algorithms to recognize complex patterns in the pressure data that might not be apparent through simple threshold-based comparisons. These algorithms can learn from historical data to improve their accuracy in distinguishing between normal pressure variations and those indicative of leaks. The contextual analysis may also take into account external factors that could affect pressure readings, such as weather conditions or planned network operations. In some examples, this step may involve the use of advanced statistical techniques, such as time series analysis or Bayesian inference, to quantify the likelihood of a leak based on observed pressure deviations from historical norms.

In some aspects, an actual vs. expected head conditions analysis may be performed at 1314. In some aspects, performing the actual vs expected head conditions analysis at 1314 may involve comparing the measured pressure readings (expressed as hydraulic head) at each sensor location with the expected values based on the network's hydraulic model or schematic. This comparison helps identify discrepancies that may indicate the presence of leaks or other anomalies in the system. In some aspects, performing the actual vs expected head conditions analysis at 1314 may utilize sophisticated hydraulic modeling software to generate expected pressure profiles for the network under current demand and operational conditions. These models can take into account factors such as pipe friction, elevation changes, and known system characteristics to provide accurate predictions of expected pressures throughout the network. The analysis process may involve statistical methods to quantify the significance of any observed deviations between actual and expected head conditions. In some examples, this step may also incorporate uncertainty analysis to account for potential errors in both measurements and model predictions, providing a more robust assessment of potential leak indicators.

In some aspects, one or more head schematics for one or more pressure recorders may be provided at 1316. In some aspects, the one or more head schematic may provide a visual representation of the expected pressure distribution across the network. This schematic aids in understanding the hydraulic profile of the system and serves as a reference for comparing actual pressure measurements. In some aspects, the one or more head schematics may be dynamically updated based on current operational conditions and demand patterns. This allows for more accurate comparisons between expected and actual pressure readings, taking into account the changing hydraulic state of the network throughout the day. The head schematic may incorporate color-coding or other visual cues to highlight areas of the network with different pressure zones or expected pressure ranges. In some examples, this component may allow for interactive exploration of the pressure data, enabling operators to zoom in on specific areas of interest or overlay actual pressure readings on the schematic for easy comparison.

In some aspects, the system may determine if there are one or more deviations at 1318. The deviations at 1318 decision point represents a juncture in the leak detection process where the system determines whether the analyzed pressure data indicates significant deviations from expected conditions. This decision may be based on the results of the contextual and actual vs expected head conditions analyses. In some aspects, the deviations at 1318 decision may involve a scoring system that quantifies the magnitude and significance of observed pressure deviations. This nuanced approach can help prioritize follow-up actions based on the severity and confidence level of detected anomalies. The decision-making process at this point may also incorporate historical performance data to adjust its sensitivity over time. In some examples, machine learning techniques could be employed to continuously refine the criteria for identifying significant deviations, improving the system's accuracy in distinguishing between true leaks and false positives.

The “E” (e.g., 1320) and “F” (e.g., 1322) connectors in FIG. 13A link to corresponding points in FIG. 13B, indicating the flow of the process based on whether significant deviations are detected or not. These connectors ensure a logical progression of the leak detection workflow across the two diagrams.

FIG. 13B illustrates the subsequent steps in the leak detection process, focusing on leak localization and response actions. The figure shows two main paths: one for when significant deviations are detected (starting from connector “E”) and another for when no significant deviations are found (starting from connector “F”).

In some aspects, one or more model simulations may be initiated at 1324. Initiation of one or more model simulations at 1324 may involve running hydraulic model simulations to predict network behavior under various leak scenarios. These simulations help in localizing the potential leak by comparing modeled outcomes with observed pressure data. In some aspects, initiating one or more model simulations at 1324 may include utilizing one or more advanced computational techniques, such as parallel processing or cloud computing, to run multiple simulations quickly and efficiently. This allows for the exploration of a wide range of possible leak scenarios in a short time frame. The model simulations may incorporate a wide range of parameters, including network topology, pipe characteristics, and historical consumption patterns. In some examples, initiating one or more model simulations at 1324 may employ ensemble modeling techniques, running multiple simulations with slightly different parameters to account for uncertainties in the input data and model assumptions.

In some aspects, the most probable leak location may be identified at 1326. Identifying the most probable leak location at 1326 may involve analyzing the results of the model simulations to determine the most likely location of the leak based on the observed pressure data and simulated scenarios. This process narrows down the search area for field teams to investigate, improving the efficiency of leak detection and repair efforts. In some aspects, identifying the most probable leak location at 1326 may include employing probabilistic methods to rank potential leak locations based on their likelihood. This ranking can help prioritize field investigations and allocate resources more effectively. The identification process may also take into account practical considerations, such as the accessibility of different parts of the network or the potential impact of a leak in various locations. In some examples, this may involve integrating GIS data to provide additional context for the identified locations, facilitating more efficient field responses.

The end 1328 step represents the completion of the current cycle of the leak detection and analysis process. It signifies that all necessary actions for the current iteration have been taken, whether that involves initiating a response to a detected leak or logging the results of a normal analysis. In some aspects, the end 1328 step may trigger a series of wrap-up actions, such as generating summary reports of the analysis cycle, updating performance metrics, or scheduling the next iteration of the leak detection process. The end 1328 step may also serve as a checkpoint for system health checks, ensuring that all components of the leak detection system are functioning correctly before beginning the next cycle. In some examples, this may involve running diagnostic tests or performing routine maintenance tasks to maintain the accuracy and reliability of the leak detection process.

The location of a deviation occurrence may be noted at 1330. In some aspects, noting the location of the deviation occurrence at 1330 may involve recording the specific locations within the network where pressure deviations were detected. This information can be important for focusing subsequent analysis and field investigations on the most relevant areas. In some aspects, noting the location of the deviation occurrence at 1330 may involve creating detailed geospatial records of the anomalies, including not just the location but also the magnitude and duration of the observed pressure deviations. This comprehensive recording can aid in pattern recognition across multiple detection cycles. The noted locations may be prioritized based on the severity of the deviations or their potential impact on the network. In some examples, this step may also involve correlating the deviation locations with other relevant data, such as pipe age, maintenance history, or previous leak incidents in the area, to provide a more comprehensive context for the observed anomalies.

In some aspects, a potential leak location may be generated at 1332. In some aspects, generating the potential leak location at 1332 may involve using the noted deviation locations and other relevant data to identify specific areas within the network where leaks are most likely to be present. This process helps to further narrow down the search area for field investigations. In some aspects, generating the potential leak location at 1332 may include employing advanced spatial analysis techniques to consider factors such as network topology, pipe materials, and historical leak patterns in determining the most probable leak locations. This can include the use of machine learning algorithms trained on historical leak data to improve prediction accuracy. The generation of potential leak locations may also involve a risk assessment component, evaluating the potential consequences of leaks in different areas of the network. In some examples, this step may produce a prioritized list of locations for investigation, taking into account both the likelihood of a leak and its potential impact on the system and surrounding infrastructure. Generating the potential leak location at 1332 may also incorporate data from other sources, such as acoustic sensors or satellite imagery, to further refine the leak localization process. In some aspects, this step may utilize a multi-criteria decision analysis approach, weighing various factors to determine the most likely leak locations. The outcome of this step serves as an important input for field teams, guiding their investigation efforts and potentially reducing the time and resources required to locate and repair leaks. In some examples, the system may generate detailed reports or maps highlighting the potential leak locations, complete with confidence levels and recommended investigation strategies.

While not explicitly shown in FIG. 13A or 13B, the leak detection process may include additional steps or feedback loops to continuously improve the system's performance. For instance, the results of field investigations could be used to validate and refine the leak detection algorithms and models. In some aspects, the system may incorporate a machine learning component that adapts over time based on the outcomes of past leak detection efforts. This adaptive capability could help improve the accuracy of future leak predictions and reduce false positives. The overall process depicted in FIGS. 13A and 13B represents a comprehensive approach to leak detection that combines real-time pressure monitoring, historical data analysis, and advanced hydraulic modeling. By integrating these various components, the system aims to provide water utilities with a powerful tool for identifying and localizing leaks quickly and efficiently.

In some examples, the system may be designed to operate continuously, performing regular analyses and alerting operators to potential issues as they arise. This proactive approach can help utilities address leaks before they develop into more serious problems, potentially saving water resources and reducing infrastructure damage. The modular nature of the process allows for flexibility in implementation, with utilities able to adapt the system to their specific needs and existing infrastructure. In some aspects, the system could be integrated with other utility management tools, such as asset management systems or customer relationship management platforms, to provide a more holistic approach to water network management. While the focus of this disclosure is on leak detection, the principles and methods described could potentially be applied to other aspects of water network management, such as water quality monitoring or demand forecasting.

In some examples, the system could be expanded to incorporate additional data sources or analytical techniques as they become available, ensuring that it remains at the forefront of water network management technology. The leak detection process described in FIGS. 13A and 13B represents a significant advancement in the field of water network management. By leveraging advanced data analysis techniques and hydraulic modeling, it offers water utilities a powerful tool for maintaining the integrity of their distribution networks and conserving valuable water resources. In accordance with aspects of the present disclosure, the system's ability to quickly identify and localize potential leaks can lead to significant improvements in operational efficiency, reduced water loss, and enhanced customer service. As water scarcity becomes an increasingly pressing issue in many parts of the world, such innovative approaches to leak detection and water conservation will likely play a crucial role in ensuring sustainable water management practices.

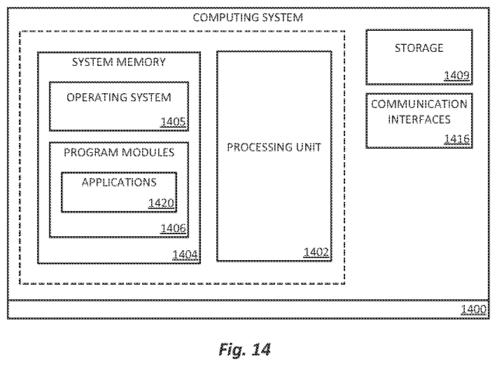

FIG. 14 is a block diagram illustrating physical components (e.g., hardware) of a computing system 1400, such as a hydraulic analysis platform, with which aspects of the disclosure may be practiced. The computing system 1400 components described below may be suitable for the computing and/or processing devices described above. In a basic configuration, the computing system 1400 may include at least one processing unit 1402 and a system memory 1404. Depending on the configuration and type of computing device, the system memory 1404 may comprise, but is not limited to, volatile storage (e.g., random-access memory (RAM)), non-volatile storage (e.g., read-only memory (ROM)), flash memory, or any combination of such memories.

The system memory 1404 may include an operating system 1405 and one or more program modules 1406 suitable for running software application 1420, such as one or more components supported by the systems described herein. As examples, system memory 1404 may include a data model 122/204, hydraulic model 126/216 and/or a water mass balance process 212. The computing system 1400 may have additional features or functionality. For example, the computing system 1400 may also include additional data storage devices (removable and/or non-removable) such as, for example, magnetic disks, optical disks, or tape. Such additional storage is illustrated in FIG. 14 by a removable and non-removable storage 1409.

As stated above, a number of program modules and data files may be stored in system memory 1404. While executing on the processing unit 1402, the program modules (e.g., data model 122/204, hydraulic model 126/216 and/or a water mass balance process 212) 1406 may perform processes including, but not limited to, the aspects, as described herein.

Furthermore, embodiments of the disclosure may be practiced in an electrical circuit, discrete electronic element, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 14 may be integrated onto a single integrated circuit. Such an SOC device may include one or more processing units, graphics units, communications units, system virtualization units and various application functionality, all of which are integrated (or “burned”) onto the chip substrate as a single integrated circuit. When operating via an SOC, the functionality, described herein, with respect to the capability of client to switch protocols may be operated via application-specific logic integrated with other components of the computing system 1400 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

The computing system 1400 may also have one or more input device(s) such as a keyboard, a mouse, a pen, a sound or voice input device, a touch or swipe input device, etc. Output device(s) such as a display, speakers, a printer, etc. may also be included. The aforementioned devices are examples and others may be used. The computing system 1400 may include one or more communication interface 1416, allowing communications with other computing devices and information systems. Examples of a communication interface 1416 include, but are not limited to, radio frequency (RF) transmitter, receiver, and/or transceiver circuitry; universal serial bus (USB), parallel, and/or serial ports.

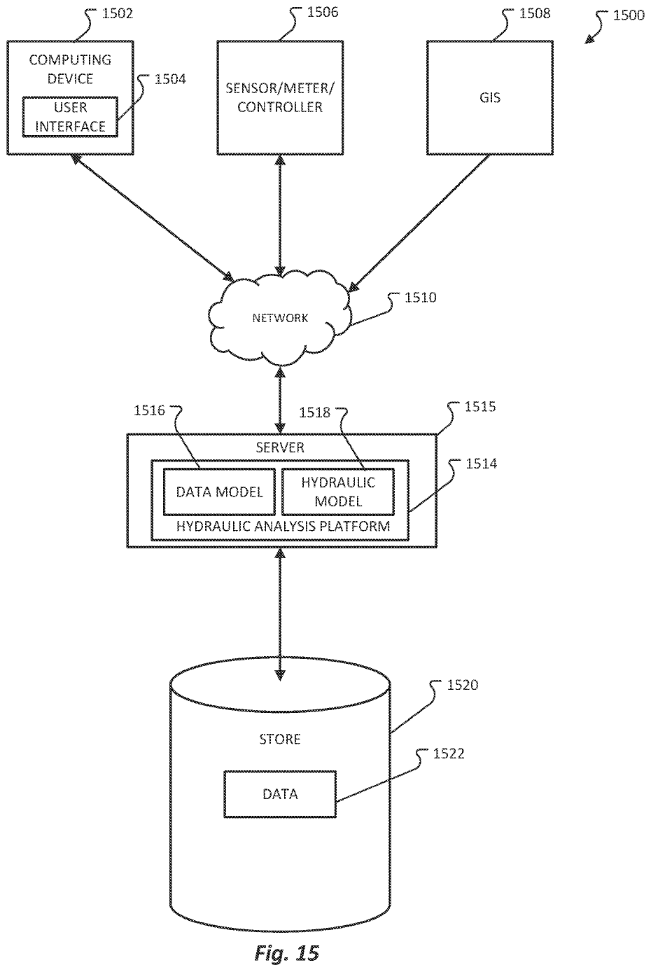

FIG. 15 illustrates details of a system 1500 for processing data received at a computing system from a remote source, such as a computing device 1502, sensor, meter, and/or controller 1506, and/or GIS 1508 as previously described. In examples, a hydraulic analysis platform 1514, including one or more of a data model 1516 and/or hydraulic model 1518, can be employed by a server device 1512. The server device 1512 can be the same as or similar to the computing system 1400 of FIG. 14 and/or the computing system 202 of FIG. 2. The hydraulic analysis platform 1514 can be the same as or similar to the hydraulic analysis platform 200 of FIG. 2; the data model can be the same as or similar to the data model 122 of FIG. 1 and/or data model 204 of FIG. 2; and the hydraulic model can be the same as or similar to the hydraulic model 126/128 of FIG. 1 and/or hydraulic model 216 of FIG. 2. The server device 1512 can provide data to and from the computing device 1502 through a network 1510, where the computing device 1502 can be one or more of a personal computer, a tablet computing device, and/or a mobile computing device (e.g., a smart phone).

In examples, sensor/meter/controller 1506 can refer to AMI (e.g., AMI 208 of FIG. 2), SCADA (e.g., SCADA 210 of FIG. 2), impulse pressure sensors/recorders (e.g., impulse pressure sensors/recorders 209 of FIG. 2) or other data providers. Thus, sensor/meter/controller 1506 can provide data to the server device 1512 for additional processing. In examples, the server device 1512 can communicate information to the computing device 1502, where the computing device 1502 can cause one or more graphical depictions of the data to be rendered to a user interface 1504. In some examples, the server device 1512 can communicate information to the sensor/meter/controller 1506 to control one or more aspects of a water utility infrastructure. In examples, the store 1520 can store data 1522, where the data 1522 can refer to sensor data, meter data, impulse data, GIS data, water utility infrastructure data, etc. used by and/or generated by the hydraulic analysis platform 1514.

In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices.

The leak detection and localization system described in FIGS. 11A-13B can be implemented within the computing system architecture outlined in FIG. 14 of the application. Specifically, the system may reside on one or more computing devices, each comprising a processing unit 1402, system memory 1404, and storage 1409. The various modules and components of the leak detection system, including data acquisition, analysis, and simulation modules, can be implemented as program modules 1406 stored in the system memory 1404 and executed by the processing unit 1402. The system may also utilize communication interfaces 1416 to receive data from sensors, AMI, and SCADA systems distributed throughout the water network. In some aspects, the system may leverage cloud computing resources for additional processing power, particularly for computationally intensive tasks such as hydraulic model simulations.

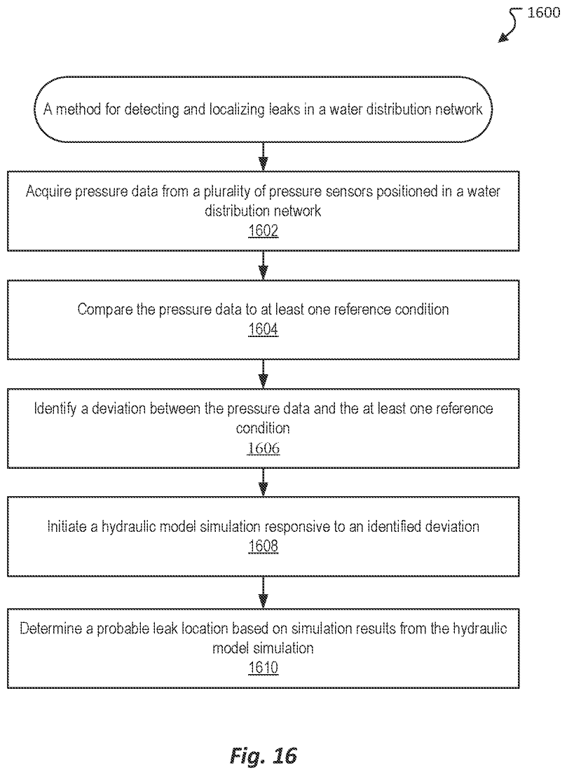

FIG. 16 depicts a method 1600 for detecting and localizing leaks in a water distribution network. In conjunction with certain components and data flows shown in FIGS. 1-15, method 1600 may be implemented in one or more systems configured to detect and localize leaks in a water distribution network.

Method 1600 begins at block 1602 with acquiring pressure data from a plurality of pressure sensors positioned in a water distribution network. Turning briefly to FIG. 1, data model element 102 may incorporate sensor inputs as outlined by sensor node 106 or 108, each configured to measure pressure or flow data. Additionally, FIG. 2 illustrates an example of distributed sensing devices capable of transmitting real-time or near-real-time pressure readings to a central server or data model 200. The acquired sensor data may include time-stamped measurements of system pressure at various points within the network. As detailed in FIG. 3A (e.g., one or more sensors 304, 306, 308), pressure data may be organized alongside other sensor metrics (e.g., flow, quality) to enable integrated analysis. The collection and transmission of these data points may provide inputs for subsequent leak-detection steps of method 1600.

As illustrated and discussed with respect to FIG. 11A, a system collects real-time or near-real-time data from strategically placed sensors throughout the distribution network. These figures also reference associated SCADA/AMI inputs for broader context. Acquiring high-resolution sensor data may contribute to a technical solution of enabling continuous monitoring of network conditions and forming the basis for subsequent anomaly detection. Thus, the reliable, high-frequency pressure measurements may reduce reliance on sporadic manual checks, allowing continuous network awareness and significantly enhancing detection sensitivity. This real-time visibility into water distribution assets directly addresses the problem of delayed leak detection and unaccounted-for water losses.

Method 1600 then proceeds to block 1604 with comparing the pressure data to at least one reference condition. In some aspects of method 1600, the at least one reference condition includes at least one of: historical pressure data for a similar demand condition, or expected pressure data based on a hydraulic model. In certain embodiments, a reference condition may comprise historical pressure data, expected hydraulic profiles, or other baseline conditions modeled within the system's data architecture. For example, FIGS. 1-4B illustrate how baseline parameters or model libraries may be stored. These libraries can be used to generate expected pressure values under similar demand conditions, thus establishing a reference curve or threshold. In some aspects, the comparison step may incorporate water usage data from FIG. 4A or FIG. 4B, particularly where usage restrictions or demand profiles (e.g., element 402 or 404) contribute to understanding “normal” or “allowed” conditions. As described with reference to FIG. 11A-13B, this comparison may draw upon historical datasets, hydraulic modeling projections, or other baseline conditions. In some aspects, by comparing current sensor readings to expected or historical trends, the method 1600 may distinguish normal operating fluctuations from anomalies indicative of leaks. This significantly improves diagnostic accuracy versus simplistic threshold-based methods, creating a robust foundation for subsequent model simulations.

Method 1600 then proceeds to block 1606 with identifying a deviation between the pressure data and the at least one reference condition. For example, system software may detect an anomalous drop in pressure or an out-of-range reading indicating a potential leak event. In some aspects, one or more elements can log, highlight, or otherwise mark these deviations. Similarly, a deviation alert can be stored or displayed once current sensor data no longer aligns with the reference condition. Detecting deviations at an early stage allows for proactive troubleshooting. In some aspects, the ability to isolate subtle, localized deviations addresses the technical challenge of accurately pinpointing potential leak sites in large networks.

Method 1600 then proceeds to block 1608 with initiating a hydraulic model simulation responsive to an identified deviation. In FIG. 3B, multiple model variants can be executed to compare different system conditions, pipe characteristics, friction factors, and the like. By engaging the hydraulic model promptly upon detecting a potential issue, the system refines its leak-location hypothesis. This near-real-time simulation approach is further informed by usage logs (e.g., FIG. 4A) and usage policies or thresholds (e.g., FIG. 4B). As shown in FIGS. 11B, 12B, and 13B, a system may trigger real-time or near-real-time simulations within a calibrated hydraulic model to explore how an ongoing leak (or abnormal usage) might be influencing the network's pressure and flow profiles. Incorporating up-to-date sensor data into dynamic simulations yields accurate leak localization versus static, purely historical methods. By running iterative or on-demand simulations, the aspect of the present disclosure describes providing timely responses to anomalies, which may be important for mitigating water losses and reducing service disruptions.

Method 1600 then ends at block 1610 with determining a probable leak location based on simulation results from the hydraulic model simulation. In certain aspects, the system may generate a user notification or alert, which may be logged in a data repository or communicated to field personnel. Such notifications can incorporate visualization overlays, as described in FIG. 2 to highlight nodes or pipes in question. Additionally, subsequent updates to the hydraulic model are possible if field measurements confirm or refute the system's initial leak location.

In some aspects, method 1600 further comprises analyzing stored pressure data over multiple demand cycles and updating at least one reference condition. Such analysis may utilize a historical database to adjust baseline expectations based on evolving network patterns. Incorporating multi-cycle data ensures that transient anomalies are not falsely flagged, enhancing the robustness of the method's detection capabilities.

In some aspects, method 1600 further comprises identifying a usage pattern within the water distribution network; adjusting at least one reference condition to account for the identified usage pattern; and updating one or more parameters of the hydraulic model simulation based on the adjusted at least one reference condition. In some aspects, this usage pattern detection may rely on sensor inputs and learned profiles of demand, allowing the system to recalibrate the hydraulic model for more accurate simulation of network behavior under typical or unusual flow conditions.

In some aspects, method 1600 further comprises generating a notification containing visualization data representing the identified deviation, the probable leak location, and at least one recommended inspection procedure. By providing structured alerts (e.g., through a user interface), stakeholders receive both textual and graphical cues, expediting decision-making and facilitating targeted field responses to suspicious conditions.

In some aspects of method 1600, generating the notification comprises: creating a graphical overlay of sensor nodes on a map of the water distribution network; highlighting nodes associated with the identified deviation using visual indicators; and appending simulation output charts to guide field technicians in locating the probable leak location. In some aspects, visual enhancements help operators rapidly interpret sensor data and understand the magnitude and location of a suspected leak. Appended charts or graphs from the hydraulic model can further clarify recommended inspection steps.

In some aspects, method 1600 further comprises recalibrating the hydraulic model based on actual flow measurements recorded at the probable leak location post-repair. In some aspects, this recalibration aligns the simulated model with updated network conditions after a leak is remedied, thus ensuring future leak detection remains accurate and reflective of the newly established baseline.

In some aspects of method 1600, recalibrating the hydraulic model comprises: capturing updated flow and pressure readings after an identified leak is repaired; comparing the updated flow and pressure readings to prior simulation outputs; and adjusting at least one model parameter to align simulated pressure curves with new baseline data. In some aspects, this recalibration aligns the simulated model with updated network conditions after a leak is remedied, thus ensuring future leak detection remains accurate and reflective of the newly established baseline. In some aspects, recalibration eliminates outdated assumptions in the model library and enhances predictive accuracy for detecting subsequent leak events or deviations under similar conditions.

In some aspects of method 1600, identifying the deviation comprises: comparing pressure readings from at least two sensors under substantially similar demand conditions, and detecting a possible leak when a measured difference between the at least two sensors exceeds a threshold value. In some aspects, such a multi-sensor comparison leverages distributed measurement points to isolate localized pressure drops. By focusing on comparable conditions, the method 1600 reduces false positives attributable to short-term usage fluctuations or standard variations.

In some aspects, method 1600 further comprises: determining an expected pressure difference between the at least two sensors based on at least one pipe characteristic, the at least one pipe characteristic being at least one of: length, diameter, or friction losses; calculating an actual pressure difference between the at least two sensors based on the pressure data; and flagging the deviation if the actual pressure difference exceeds an expected difference by more than a predefined threshold. In some aspects, known pipeline properties stored in a data model can be used to establish a normative pressure differential. A discrepancy beyond normal variance may indicate a leak, prompting further investigation or simulation.

In some aspects, method 1600 further comprises: prioritizing leak alerts based on at least one of: leak size estimation, service impact, or proximity to critical infrastructure; and transmitting the prioritized leak alerts through two or more communication channels. By incorporating severity metrics, the method 1600 helps to ensure that high-risk leaks (e.g., near essential facilities) receive immediate attention. Multi-channel notifications—including text, email, or SCADA-based alerts—broaden the reach of urgent leak warnings.

In some aspects of method 1600, comparing the pressure data to the at least one reference condition further comprises: applying one or more machine learning techniques to update the at least one reference condition based on historical data inputs, and refining the at least one reference condition over time to enhance detection of deviations that indicate potential leaks. Such adaptive modeling may rely on historical sensor data to learn normal system behaviors. Over time, incremental updates to the reference condition reduce the likelihood of false positives and improve the detection of subtle leaks.

In some aspects of method 1600, identifying the deviation further comprises: utilizing one or more machine learning techniques to set or adjust at least one threshold for detecting anomalies in the pressure data, and adapting the at least one threshold over time to improve distinction between normal pressure variations and potential leak indicators. Intelligent thresholding methods may rely on iterative training and feedback loops. By continuously refining anomaly-detection criteria, the system can learn a more nuanced understanding of routine pressure fluctuations, improving the accuracy of leak detection under various operating conditions.

In some aspects, method 1600, or any aspect related to it, may be performed by an apparatus, such as the computing system 1400 of FIG. 14 or the server 1515 of FIG. 15, each of which includes various components operable, configured, or adapted to perform the steps of method 1600. In certain embodiments, these components may include one or more processors (e.g., 1402 in FIG. 14), system memory (e.g., 1404), communication interfaces (e.g., 1416), and other modules (e.g., 1406, 1409, 1420) arranged to implement or execute aspects of method 1600. In additional or alternative embodiments, the hydraulic analysis platform 1500 of FIG. 15, or its user interface 1504 and data/hydraulic models, may be adapted to carry out the method steps and sub-steps described in connection with method 1600.

Note that FIG. 16 is just one example of a method, and other methods including fewer, additional, or alternative operations are possible consistent with this disclosure.

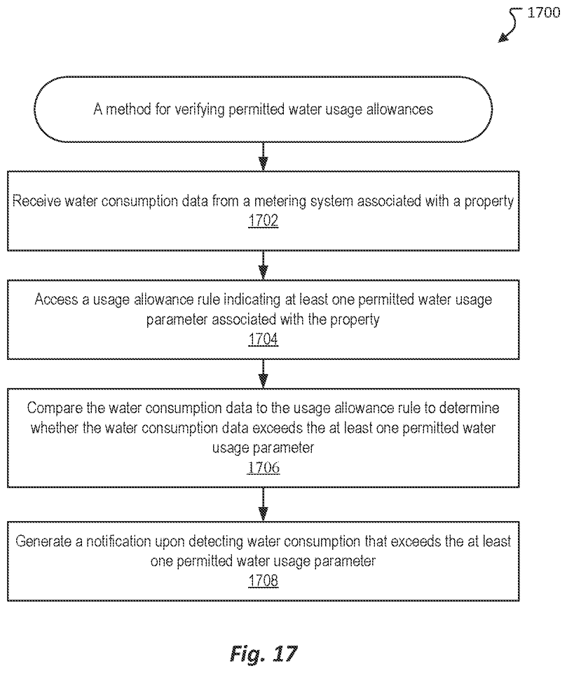

FIG. 17 depicts a method 1700 for verifying permitted water usage allowances. In conjunction with certain components and data flows shown in FIGS. 1-15, method 1700 may be implemented in one or more systems configured to verify permitted water usage allowances. Method 1700 may be implemented by one or more devices (see, e.g., computing system 1400 of FIG. 14, server 1515 of FIG. 15) configured to verify permitted water usage allowances for a given property or set of properties. In some aspects, method 1700 addresses the technical problem of effectively monitoring and enforcing water consumption constraints, especially in large-scale water distribution or management environments.

Method 1700 begins at block 1702 with receiving water consumption data from a metering system associated with a property. In certain aspects, a metering system may be part of an advanced metering infrastructure (AMI), as referenced in FIG. 2, which may continuously or periodically collects consumption readings from individual properties. Additionally, FIG. 4A illustrates an example usage log (element 402) capturing customer IDs, time stamps, usage volumes, and potential events. This collected consumption data forms the basis for subsequent comparisons to permitted usage rules. Automating the retrieval of water consumption data in real time or near-real time reduces manual data collection errors and helps to ensure that the system has up-to-date information. This direct data flow from metering systems addresses the technical problem of fragmented data sources, enabling integrated usage verification.

Method 1700 then proceeds to block 1704 with accessing a usage allowance rule indicating at least one permitted water usage parameter associated with the property. Such usage allowance rules can be stored or defined in a data model analogous to FIG. 1 or reflected in the usage policy definitions shown in FIG. 4B. These rules may specify daily, weekly, or monthly permitted usage thresholds, allowable usage days (e.g., M/W/F), or other conditions tied to regulatory mandates or internal utility policies. In some aspects, the system centralizes usage allowances in a repository that may integrate historical baselines, dynamic policy updates, and real-time sensor inputs. This unified rule-based architecture solves the technical problem of inconsistent or unclear usage criteria by standardizing and automating the enforcement of water usage parameters.

Method 1700 then proceeds to block 1706 with comparing the water consumption data to the usage allowance rule to determine whether the water consumption data exceeds the at least one permitted water usage parameter. In some implementations, the system may leverage prior usage analytics to refine the comparison. For example, as shown in FIG. 4A, event records and usage volumes can be filtered or aggregated to detect when a measured volume surpasses a designated allowance. Additional system intelligence may be described with respect to FIG. 5, though originally illustrating pressure comparisons, a similar structure could be adapted for usage comparisons to ascertain consumption anomalies. Automating this comparison step helps to ensure consistent, rule-based evaluations of water use. By systematically detecting overages, the method 1700 can addresses the technical challenge of real-time compliance monitoring, helping property owners and regulatory bodies maintain water usage within permissible limits.

Method 1700 then ends at block 1708 with generating a notification upon detecting water consumption that exceeds the at least one permitted water usage parameter. This notification can be transmitted to relevant stakeholders (e.g., property owners, utility staff, or regulatory authorities) via the user interface shown in FIG. 2 or integrated computing devices depicted in FIGS. 14-15. In various aspects, the system can attach usage data logs (such as those in FIG. 4A) to detail the noncompliant intervals or volumes. Prompt alerts allow immediate remedial actions. The ability to automate notifications ensures that usage violations are flagged quickly, reducing delayed response times and mitigating water waste or regulatory infractions.

In some aspects, method 1700 further comprises: storing water consumption data for the property in a repository over multiple usage intervals; and determining a baseline usage pattern for the property based on the stored water consumption data. This storage enables the system to evaluate consumption trends over time and differentiate consistent usage patterns from anomalous spikes. By establishing a reliable reference baseline, the system can more accurately identify and flag deviations that may indicate overconsumption or irregular behavior.

In some aspects, method 1700 further comprises: comparing the baseline usage pattern to the at least one permitted water usage parameter; and adjusting the usage allowance rule when the baseline usage pattern differs from the at least one permitted water usage parameter by a threshold value. Through this comparison, the system refines water allowance rules to better align with actual consumption behaviors. Adjusting the usage allowance rule based on deviations helps reduce unwarranted notifications and ensures usage thresholds remain fair and representative of real conditions.

In some aspects of method 1700, analyzing the stored water consumption data comprises: applying a machine-learning model to the stored water consumption data to identify seasonal usage trends; and comparing real-time water consumption data to a predicted water consumption value output from the machine-learning model to detect a water usage anomaly. The machine-learning approach enhances the method's adaptability by learning periodic or seasonal fluctuations that may affect usage. By comparing real-time data with predicted values, the system can more quickly recognize anomalies and alert stakeholders to potential issues.

In some aspects, method 1700 further comprises: receiving at least one of weather data or climate data that is relevant to the property; correlating the received at least one of weather data or climate data with the identified seasonal usage trends; and updating the usage allowance rule to account for anticipated shifts in water demand based on the correlated data. Incorporating weather or climate data introduces a proactive dimension to usage allowance adjustments. In some aspects, this correlation accounts for environmental factors that can increase or reduce normal consumption, thereby enhancing the accuracy of threshold settings and reducing false positives.

In some aspects, method 1700 further comprises categorizing each instance of excessive water consumption based on severity levels, wherein each severity level corresponds to an extent of deviation from the at least one permitted water usage parameter. This categorization structure assists in classifying overconsumption events, allowing the system to prioritize responses and resources. By assigning severity levels, stakeholders gain a clearer understanding of the magnitude of any given usage violation.

In some aspects, method 1700 further comprises recommending at least one corrective measure for each severity level; and applying more stringent corrective actions at higher-severity levels of usage deviation. In some aspects, mitigation steps may be proportionate to the severity of the deviation, preventing overreaction to minor overages while responding decisively to major or repeated violations. Adopting a tiered strategy optimizes resource utilization and user engagement.

In some aspects of method 1700, the at least one corrective measure includes sending an alert to a regulatory authority if a number of severe violations exceeds a specified threshold within a defined period. Such reporting mechanisms facilitate compliance oversight and encourage timely resolution. By coordinating with regulatory bodies, the method 1700 promotes accountability and helps ensure that usage allowances remain aligned with broader water management goals.

In some aspects, method 1700 further comprises: retrieving consumer contact preferences from a database; and selecting a notification channel based on the retrieved consumer contact preferences, wherein the notification channel includes at least one of email, text message, phone call, or a mobile application alert. Customizing notifications to user preferences maximizes the likelihood of prompt awareness and action. This flexibility accommodates different communication methods, ensuring wide applicability across user demographics.

In some aspects, method 1700 further comprises creating a time-based usage report that includes: total consumption over a specified period; total permitted usage over a same period; and a calculated difference between consumption and permitted usage. By providing a consolidated overview, the time-based usage report offers transparency and clarity regarding a property's compliance status. This summary allows stakeholders to gauge current performance and plan corrective measures if necessary.

In some aspects, method 1700 further comprises transmitting the time-based usage report to at least one external entity including at least one of: a regulatory agency, a water utility, or a property management organization for compliance tracking. Disseminating reports to external entities fosters collaboration and shared responsibility in managing water resources. Such communication improves oversight, strengthens enforcement, and can inform future policy or infrastructure decisions.

In some aspects, method 1700 further comprises collecting user feedback regarding possible reasons for water usage spikes and incorporating that feedback into future modifications of the usage allowance rule. Soliciting user feedback enables the system to learn from real-world circumstances that might cause anomalous consumption. By integrating these insights, the method 1700 can be more adaptable, reducing unwarranted alerts and refining usage parameters.

In some aspects of method 1700, incorporating the user feedback comprises: recalculating one or more permitted usage parameters to accommodate documented usage spikes; verifying that the recalculated one or more permitted usage parameters align with applicable municipal or regulatory standards; and updating the usage allowance rule in a central database for subsequent comparisons. In some aspects, this feedback mechanism helps to ensure that the system remains accurate and compliant with prevailing regulations. Aligning recalculated usage parameters with local standards balances consumer needs with regulatory mandates, preserving both functionality and integrity of the overall process.

In some aspects, method 1700, or any aspect related to it, may be performed by an apparatus, such as the computing system 1400 of FIG. 14 or the server 1510 of FIG. 15, each of which includes various components operable, configured, or adapted to perform the steps of method 1700. In certain embodiments, these components may include one or more processors (e.g., 1402 in FIG. 14), system memory (e.g., 1404), communication interfaces (e.g., 1416), and other modules (e.g., 1406, 1409, 1420) arranged to implement or execute aspects of method 1700. In additional or alternative embodiments, the hydraulic analysis platform 1500 of FIG. 15, or its user interface 1504 and data/hydraulic models, may be adapted to carry out the method steps and sub-steps described in connection with method 1700.

Note that FIG. 17 is just one example of a method, and other methods including fewer, additional, or alternative operations are possible consistent with this disclosure.

Implementation examples are described in the following numbered clauses:

Clause 1: A method for detecting and localizing leaks in a water distribution network, the method comprising: acquiring pressure data from a plurality of pressure sensors positioned in a water distribution network; comparing the pressure data to at least one reference condition, the at least one reference condition being at least one of: historical pressure data for a similar demand condition, or expected pressure data based on a hydraulic model; identifying a deviation between the pressure data and the at least one reference condition; initiating a hydraulic model simulation responsive to an identified deviation; and determining a probable leak location based on simulation results from the hydraulic model simulation.

Clause 2: The method of Clause 1, further comprising analyzing stored pressure data over multiple demand cycles and updating the at least one reference condition.

Clause 3: The method of any one of Clauses 1-2, further comprising: identifying a usage pattern within the water distribution network; adjusting the at least one reference condition to account for the identified usage pattern; and updating one or more parameters of the hydraulic model simulation based on the adjusted at least one reference condition.

Clause 4: The method of any one of Clauses 1-3, further comprising: generating a notification containing visualization data representing the identified deviation, the probable leak location, and at least one recommended inspection procedure.

Clause 5: The method of Clause 4, wherein generating the notification comprises: creating a graphical overlay of sensor nodes on a map of the water distribution network; highlighting nodes associated with the identified deviation using visual indicators; and appending simulation output charts to guide field technicians in locating the probable leak location.

Claim 6: The method of any one of Clauses 1-5, further comprising: recalibrating the hydraulic model based on actual flow measurements recorded at the probable leak location post-repair.

Clause 7: The method of Clause 6, wherein recalibrating the hydraulic model comprises: capturing updated flow and pressure readings after an identified leak is repaired; comparing the updated flow and pressure readings to prior simulation outputs; and adjusting at least one model parameter to align simulated pressure curves with new baseline data.

Clause 8: The method of any one of Clauses 1-7, wherein identifying the deviation comprises: comparing pressure readings from at least two sensors under substantially similar demand conditions, and detecting a possible leak when a measured difference between the at least two sensors exceeds a threshold value.

Clause 9: The method of Clause 8, further comprising: determining an expected pressure difference between the at least two sensors based on at least one pipe characteristic, the at least one pipe characteristic being at least one of: length, diameter, or friction losses; calculating an actual pressure difference between the at least two sensors based on the pressure data; and flagging the deviation if the actual pressure difference exceeds an expected difference by more than a predefined threshold.

Clause 10: The method of any one of Clauses 1-9, further comprising: prioritizing leak alerts based on at least one of: leak size estimation, service impact, or proximity to critical infrastructure; and transmitting the prioritized leak alerts through two or more communication channels.

Clause 11: The method of any one of Clauses 1-10, wherein comparing the pressure data to the at least one reference condition further comprises: applying one or more machine learning techniques to update the at least one reference condition based on historical data inputs, and refining the at least one reference condition over time to enhance detection of deviations that indicate potential leaks.

Clause 12: The method of any one of Clauses 1-11, wherein identifying the deviation further comprises: utilizing one or more machine learning techniques to set or adjust at least one threshold for detecting anomalies in the pressure data, and adapting the at least one threshold over time to improve distinction between normal pressure variations and potential leak indicators.

Clause 13: A method for verifying permitted water usage allowances, the method comprising: receiving water consumption data from a metering system associated with a property; accessing a usage allowance rule indicating at least one permitted water usage parameter associated with the property; comparing the water consumption data to the usage allowance rule to determine whether the water consumption data exceeds the at least one permitted water usage parameter; and generating a notification upon detecting water consumption that exceeds the at least one permitted water usage parameter.

Clause 14: The method of any one of Clause 13, further comprising: storing water consumption data for the property in a repository over multiple usage intervals; and determining a baseline usage pattern for the property based on the stored water consumption data.

Clause 15: The method of claim Clause 14, further comprising: comparing the baseline usage pattern to the at least one permitted water usage parameter; and adjusting the usage allowance rule when the baseline usage pattern differs from the at least one permitted water usage parameter by a threshold value.

Clause 16: The method of claim Clause 14, wherein analyzing the stored water consumption data comprises: applying a machine-learning model to the stored water consumption data to identify seasonal usage trends; and comparing real-time water consumption data to a predicted water consumption value output from the machine-learning model to detect a water usage anomaly.

Clause 17: The method of Clause 16, further comprising: receiving at least one of weather data or climate data that is relevant to the property; correlating the received at least one of weather data or climate data with the identified seasonal usage trends; and updating the usage allowance rule to account for anticipated shifts in water demand based on the correlated data.

Clause 18: The method of any one of Clauses 13-17, further comprising categorizing each instance of excessive water consumption based on severity levels, wherein each severity level corresponds to an extent of deviation from the at least one permitted water usage parameter.

Clause 19: The method of Clause 18, further comprising: recommending at least one corrective measure for each severity level; and applying more stringent corrective actions at higher-severity levels of usage deviation.

Clause 20: The method of Clause 19, wherein the at least one corrective measure includes sending an alert to a regulatory authority if a number of severe violations exceeds a specified threshold within a defined period.

Clause 21: The method of any one of Clauses 13-20, further comprising: retrieving consumer contact preferences from a database; and selecting a notification channel based on the retrieved consumer contact preferences, wherein the notification channel includes at least one of email, text message, phone call, or a mobile application alert.

Clause 22: The method of any one of Clauses 13-21, further comprising creating a time-based usage report that includes: total consumption over a specified period; total permitted usage over a same period; and a calculated difference between consumption and permitted usage.

Clause 23: The method of Clause 22, further comprising transmitting the time-based usage report to at least one external entity including at least one of: a regulatory agency, a water utility, or a property management organization for compliance tracking.

Clause 24: The method of any one of Clauses 13-23, further comprising collecting user feedback regarding possible reasons for water usage spikes and incorporating that feedback into future modifications of the usage allowance rule.

Clause 25: The method of Clause 24, wherein incorporating the user feedback comprises: recalculating one or more permitted usage parameters to accommodate documented usage spikes; verifying that the recalculated one or more permitted usage parameters align with applicable municipal or regulatory standards; and updating the usage allowance rule in a central database for subsequent comparisons.

Clause 26: One or more apparatuses, comprising: one or more memories comprising executable instructions; and one or more processors configured to execute the executable instructions and cause the one or more apparatuses to perform a method in accordance with any one of clauses 1-25.

Clause 27: One or more apparatuses, comprising: one or more memories; and one or more processors, coupled to the one or more memories, configured to perform a method in accordance with any one of Clauses 1-25.

Clause 28: One or more apparatuses, comprising means for performing a method in accordance with any one of Clauses 1-25.

Clause 29: One or more non-transitory computer-readable media comprising executable instructions that, when executed by one or more processors of one or more apparatuses, cause the one or more apparatuses to perform a method in accordance with any one of Clauses 1-25.

Clause 30: One or more computer program products embodied on one or more computer-readable storage media comprising code for performing a method in accordance with any one of Clauses 1-25.

Clause 31: One or more systems, comprising: a processing system that includes one or more processors and one or more memories coupled with the one or more processors, the processing system configured to cause the system to perform a method in accordance with any one of Clauses 1-25.

The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

1-20. (canceled)

21. A method for detecting and localizing anomalous water usage in a water distribution network, the method comprising:
acquiring sensor data from a plurality of sensors positioned in a water distribution network, the sensor data comprising at least one of pressure data or flow data;
comparing the sensor data to at least one reference condition, the at least one reference condition being at least one of:
historical sensor data for a similar demand condition, or
expected sensor data based on a hydraulic model;
identifying a deviation between the sensor data and the at least one reference condition, wherein the deviation indicates at least one of:
a water loss event, or
a regulated demand occurring outside permitted parameters;
initiating an analysis responsive to an identified deviation; and
determining a probable location of the anomalous water usage based on results from the analysis.

22. The method of claim 21, wherein a regulated demand occurring outside permitted parameters comprises at least one of:
irrigation system activation outside permitted days or hours,
irrigation usage exceeding permitted duration or volume limits,
pool filling during restricted periods,
unauthorized hydrant usage, or
illegal connections to the water distribution network.

23. The method of claim 21, wherein when the sensor data comprises flow data from customer meters, the method further comprises:
establishing baseline consumption patterns for individual customer connections;
comparing real-time consumption data to the baseline consumption patterns; and
flagging customer connections where consumption exceeds permitted usage schedules or volume limits.

24. The method of claim 21, further comprising:
performing a mass balance analysis comparing measured inflows to outflows for a network zone;
identifying discrepancies between total inflow and total metered outflow; and
classifying identified discrepancies as potential unmetered regulated demand violations.

25. The method of claim 21, further comprising:
generating enforcement notifications for identified regulated demand violations, the enforcement notifications including at least one of: a time and date of an identified regulated demand violation, an estimated excess water volume consumed, an applicable usage restriction violated, or a customer account information when available.

26. The method of claim 21, further comprising:
applying machine learning techniques to historical consumption data to identify seasonal usage patterns;
adjusting permitted usage parameters based on identified seasonal patterns; and
updating violation detection thresholds according to time of year.

27. The method of claim 21, wherein determining the probable location comprises:
for metered connections, identifying specific customer meter identifiers associated with excessive consumption; and
for unmetered connections, using hydraulic model simulations to determine probable locations based on pressure deviations at multiple sensor points.

28. The method of claim 21, further comprising:
categorizing detected violations by severity levels based on at least one of: magnitude of excess consumption, frequency of violations, or type of restriction violated; and
prioritizing enforcement actions based on the severity levels.

29. The method of claim 21, further comprising:
upon detecting an unmetered regulated demand violation, automatically generating a control signal to a SCADA system; and
initiating valve closure at a location proximate to the probable location of the anomalous water usage.

30. A system for detecting and localizing anomalous water usage in a water distribution network, the system comprising:
a plurality of sensors positioned in a water distribution network, the plurality of sensors configured to acquire sensor data comprising at least one of pressure data or flow data;
one or more processors; and
one or more memories coupled to the one or more processors and storing instructions that, when executed by the one or more processors, cause the system to:
compare the sensor data to at least one reference condition, the at least one reference condition being at least one of:
historical sensor data for a similar demand condition, or
expected sensor data based on a hydraulic model;
identify a deviation between the sensor data and the at least one reference condition, wherein the deviation indicates at least one of:
a water loss event, or
a regulated demand occurring outside permitted parameters;
initiate an analysis responsive to an identified deviation; and
determine a probable location of the anomalous water usage based on results from the analysis.

31. The system of claim 30, wherein a regulated demand occurring outside permitted parameters comprises at least one of:
irrigation system activation outside permitted days or hours,
irrigation usage exceeding permitted duration or volume limits,
pool filling during restricted periods,
unauthorized hydrant usage, or
illegal connections to the water distribution network.

32. The system of claim 30, wherein when the sensor data comprises flow data from customer meters, the instructions further cause the system to:
establish baseline consumption patterns for individual customer connections;
compare real-time consumption data to the baseline consumption patterns; and
flag customer connections where consumption exceeds permitted usage schedules or volume limits.

33. The system of claim 30, wherein the instructions further cause the system to:
perform a mass balance analysis comparing measured inflows to outflows for a network zone;
identify discrepancies between total inflow and total metered outflow; and
classify identified discrepancies as potential unmetered regulated demand violations.

34. The system of claim 30, wherein the instructions further cause the system to:
generate enforcement notifications for identified regulated demand violations, the enforcement notifications including at least one of: a time and date of an identified regulated demand violation, an estimated excess water volume consumed, an applicable usage restriction violated, or a customer account information when available.

35. The system of claim 30, wherein the instructions further cause the system to:
apply machine learning techniques to historical consumption data to identify seasonal usage patterns;
adjust permitted usage parameters based on identified seasonal patterns; and
update violation detection thresholds according to time of year.

36. The system of claim 30, wherein to determine the probable location, the instructions cause the system to:
for metered connections, identify specific customer meter identifiers associated with excessive consumption; and
for unmetered connections, use hydraulic model simulations to determine probable locations based on pressure deviations at multiple sensor points.

37. The system of claim 30, wherein the instructions further cause the system to:
categorize detected violations by severity levels based on at least one of: magnitude of excess consumption, frequency of violations, or type of restriction violated; and
prioritize enforcement actions based on the severity levels.

38. The system of claim 30, wherein the instructions further cause the system to:
upon detecting an unmetered regulated demand violation, automatically generate a control signal to a SCADA system; and
initiate valve closure at a location proximate to the probable location of the anomalous water usage.

39. A method for detecting and localizing anomalous water usage in a water distribution network, the method comprising:
acquiring sensor data from a plurality of sensors positioned in a water distribution network, the sensor data comprising at least one of pressure data or flow data;
comparing the sensor data to at least one reference condition, the at least one reference condition being at least one of:
historical sensor data for a similar demand condition, or
expected sensor data based on a hydraulic model;
identifying a deviation between the sensor data and the at least one reference condition;
initiating an analysis responsive to an identified deviation, the analysis comprising at least one of:
a hydraulic model simulation when the sensor data comprises pressure data, or
a consumption pattern analysis when the sensor data comprises flow data; and
determining a probable anomalous water usage location based on results from the analysis.

40. The method of claim 39, further comprising analyzing stored pressure data over multiple demand cycles and updating the at least one reference condition.
